(19) United States
(12) Patent Application Publication
(10) Pub. No.: US 2002/0094863 A1
(43) Pub. Date: Jul. 18, 2002

(54) Remote establishment of game formulae and parameters auto-adjustment of par and score brackets e.g. from an administration terminal or terminals

(76) Inventor: John Klayh, Winnipeg (CA)

Correspondence Address: Shapiro Cohen, P.O. Box 3440, Station D, Ottawa, ON, K1P 6P1, CA

(21) Appl. No.: 10/033,906

(22) Filed: Jan. 3, 2002

Related U.S. Application Data
(63) Continuation of application No. 09/218,020, filed on Dec. 22, 1998.

(51) Int. Cl. A63F 13/00

(52) U.S. Cl. 463/21

(57) ABSTRACT

A system for controlling operation of an automatic game, comprising: an automatic game comprising virtual game pieces which are manipulated during playing of the game, and control hardware and software for displaying and controlling the virtual game pieces, an administration terminal for inputting and storing parameters relating to game play, and a network for downloading the parameters from the administration terminal to the game, whereby operation of the game having its control hardware and software programs stored at a location different from the administration terminal is controlled by said parameters.

### FIELD OF INVENTION

This application is a continuation application of U.S. application Ser. No. 09/218,020 filed Dec. 22, 1998.

### FIELD OF THE INVENTION

This invention relates to a method and a system for remote control of electronic game operating characteristics.

### BACKGROUND TO THE INVENTION

Games which are controlled by electronic hardware and software are in widespread use, for example video games in arcades and on personal computers (PCs), and on personal game machines. In some games, parameters which control how a game is operated can be varied by the player prior to the playing of a game, e.g. to adjust speed or skill level.

The ability to change these parameters must of course be limited when the scores achieved are to result in the awarding of prizes, since the ability to locally change these parameters can result in an unfair advantage to a player. This is particularly so in games or tournaments or prize or loyalty point redemptions in which players in general, players which have particular skill levels, or the games themselves, must be handicapped to add challenge.

For this reason, games have had fixed parameters, the player only being allowed to select skill level or speed prior to playing a game, which had been assumed to cause various players of the game within a skill level to play more or less on a level playing field. However, in a large population of players, such as those playing in a tournament across a continent or across the world, mere skill level selections have been found to be insufficiently satisfactory. In particular where players or games are to be handicapped, there is insufficient variability in the games to accommodate the players fairly, or no control over settings so that all players play on an even playing field, so to speak.

Further, games have not been able to display advertising directed to specifically identified players or to players having predetermined demographic profiles or usage patterns.

In a known system for identifying customers (which could be arcade game players), an identity card of a customer is read by a card swipe terminal which reads information stored on a magnetic strip carried by the card. The information is received at an administration office, where a computer checks the credit of the customer who is identified by the information, from a database, and provides an authorization or denial of the transaction. The transaction can be the authorization for playing of a video game.

When a debit card of a customer is swiped, a transaction value can be keyed in by the merchant or by the customer, and a PIN number is additionally keyed in by the customer. The bank account of the user, the identity of which having been previously stored in association with the PIN number and card number, is accessed, and the transaction value is debited from the bank account of the customer. This amount (less a transaction charge) is credited to the bank account of the merchant.

It is common that some credit card issuers record loyalty points, for example one point for each dollar purchased on the credit card. These points are accumulated by the credit card issuer to the credit of the customer, and can be redeemed for merchandise typically advertised in a catalogue. In some cases, the loyalty points given for use of a credit card are accumulated in conjunction with a particular vendor, such as an airline or automobile manufacture, wherein the loyalty points can be used for airline travel with that airline or as a credit toward the purchase of an automobile. Identity cards rather than credit cards are sometimes used in the awarding of airline miles or loyalty points toward catalog merchandise, for purchases from certain vendors. However, these points have not been previously awarded on the basis of scores achieved on arcade games, at least partly due to the uneven playing field as between various players of various games, which could allow certain players to unfairly accumulate an unacceptable number of loyalty points.

In all such cases, the card issuer and the vendor (e.g. the airline) each retain a simple database to keep track of the value of points accumulated and retained after redemption for travel or merchandise.

However, in each such case, there is a single authority which has issued the card, and tie-ins of a single card with a limited number (often only one) of merchants. For example, a card issuer may have a tie-in with several merchants to provide discount on merchandise or services. In such a case, no loyalty points are awarded to the customer for patronizing a particular merchant, but loyalty points can be awarded based on use of the card. The systems are not capable of dispensing or redeeming premiums or loyalty points “on-the-spot” for certain actions taken by customers, for example for patronizing certain merchants, or by trying certain video games or achieving certain score levels or brackets.

The systems are not capable of displaying advertising directed to specific customers who have identified themselves or have been identified at a terminal, nor for tracking what advertising has been displayed to particular customers, nor for controlling what advertising is shown to such customers.

The systems are also not capable of accumulating prize values or loyalty points won on games played on game terminals, nor of dispensing prizes to players, e.g. loyalty points, premiums or plays on the games.

Neither are the systems capable of allowing the loyalty points won or otherwise acquired to be used as a medium of exchange between players and member merchants, e.g. exchanging points won playing a video game for premiums which can be used at various merchants

### SUMMARY OF THE INVENTION

The present invention is a system and method which can provide for a central authority, e.g. and administrator, to create various parameters to remotely control operation of games which are located at remote locations. These parameters can control score brackets, par, scores and/or loyalty points and/or prizes to be awarded for achievement of various scores or brackets for players in general or for players of particular demographic profiles or for particular identified players, to establish personal, group or game handicap values based on past play history of players in general of a game or of players of particular demographic profile or of particular identified players, and can be comprised of algorithms which control play of the game itself.

An embodiment of the present invention is an integrated on-line system which can accumulate exchange values associated with any customer from any retailer which has authorized access to the system, including the afore noted games. The awarded exchange values for any transaction, for repetitive play of games, or for scores (handicapped or not) achieved on games, can be controlled by an administrator or by authorized plural administrators, and can in addition be varied by location of the customer, by customer activity, by time and/or date, and by past history of either the activity itself or of the actions of the customer.

In addition, the administrator can vary the characteristics of whatever software program the customer, merchant, etc. is interacting with, such as awarded loyalty points, advertisements, premiums, scores, game difficulty, characteristics of a game, award brackets, pricing by currency and/or loyalty point exchange, etc. can be controlled and varied. The program can involve scoring of sporting events, scoring of school tests, operate applications such as e-mail, etc., or it can be a video game operating in a system of the type described in U.S. Pat. No. 5,083,271 issued Jan. 21, 1992 or on personal or public computer. The program can be an advertisement displayed on a video terminal which can be one of the games described in the afore noted U.S. patent, or on a personal or public computer, or on a display or a video telephone, a network computer communicating via a private network, the internet, cable or the equivalent, or via a telephone line. The advertisement can be shown in one or more frames which share the display with a game, or can occupy the entire display area. The advertisement can be directed to a particular player, or to a class of customer to which the player belongs, and/or can be scheduled based on time and/or date and/or location at which it is to be presented. The advertisement can be changed based on various criteria, such as the location of the display, how many times it has been run, how many times it has been directed to the customer or class of customer at a particular display or display location or at plural particular or class of locations.

Games can be changed and varied as to degree of difficulty and currency or exchange value price to participate, competition brackets can be set up and varied, thresholds for prizes can be established and varied, prize and premium values can be accumulated for various activities such as plays, purchases, loyalty, and/or timing, customers or players can be authorized or disqualified, advertising can be directed to certain customers or classes of customers as noted above, premiums can be accumulated and dispensed and prizes awarded across any kind of commercial or non-commercial activity with controllable interchangeability. Since the parameters are controlled by an administration terminal, they can allow players to play not only single kinds of games, but different kinds of games individually or in tournaments, fairly and with a level playing field. Particular players or groups of players can thus be prohibited from accumulating loyalty points, premiums or prizes unfairly (e.g. unfairly to other players or unfairly to the loyalty point, premium or prize dispensing authority).

The present invention thus provides for the first time an efficient way of combining the loyalty point and premium systems of any (rather than restricted) merchants as well as the playing of software controlled games, allowing the loyalty points to be used for redemption by any of subscribing merchants including the provision of additional or subsequent game play, and at the same time gathering activity information about the customers of those merchants so that advertising may be targeted and efficiently delivered to those exact customers which can best benefit from the advertising. By the use of the term merchants, included are merchants not only of merchandise, but also of services including the services of video games.

In accordance with an embodiment of the invention, a system for controlling operation of an electronic game is comprised of control hardware and software for electronically displaying and controlling the game, the system comprising: an administration station for inputting and storing parameters relating to game play, a video game terminal in which the game is played, means for downloading the parameters from the administration station to the terminal, the control hardware and software being conditioned from the administration station and the operation of the game is controlled by said stored parameters at the administration station, the control hardware is in said video game terminal and the control software is stored in an electronic memory of the terminal.

In accordance with another embodiment, a method of controlling operation of an automatic game is comprised of providing a local automatic game having variable operating parameters, downloading the operating parameters from a database, and operating the game with the downloaded parameters.

### BRIEF DESCRIPTION OF THE DRAWINGS

A better understanding of the invention will be obtained by a consideration of the detailed description below, in conjunction with the following drawings, in which:

FIG. 1 is a block diagram of a preferred embodiment of a system on which the present invention can be implemented,

FIG. 2 is a flow chart of call initialization and loyalty point or coupon data interchange, and

FIG. 3 is a histogram of player scores against number of plays.

### DETAILED DESCRIPTION OF EMBODIMENTS OF THE INVENTION

U.S. Pat. No. 5,083,271 is incorporated herein by reference. This patent describes plural game arcades which are in communication with a central computer, or with one of plural regional computers which communicate with a central computer. The regional computers receive game score data and compute tournament winners, downloading both winner information and advertising to local games at the game arcades.

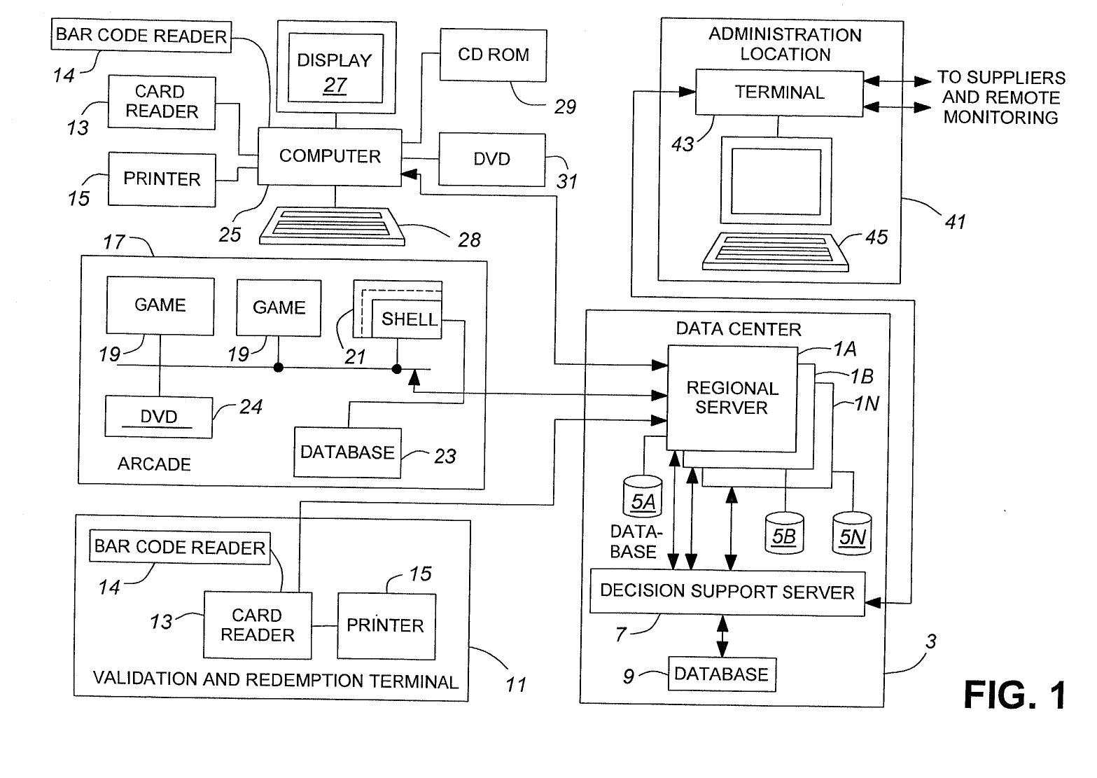

Turning to FIG. 1, in place of the regional computers described in the above-noted patent, regional servers 1A, 1B . . . 1N, etc. are used. Each regional server is located at a separate regional data center, although for convenience of illustration they are all shown in this Figure in data center 3.

Each regional server has a memory containing a corresponding database 5A, 5B . . . 5N coupled to it. In the afore noted patent, the corresponding memory stores not only score data, but also values of money on deposit to be credited against the playing of a game, and handicaps of players and/or games. In accordance with an embodiment of the invention, the databases 5A, 5B . . . 5N also store specialized data relating to parameters used in a game, such as difficulty levels, points to be awarded for certain game activities, and other functions to be described in more detail below, as well as parameters and content relating to advertising, premiums, loyalty points, etc.

The data to be stored in databases 5A . . . 5N is loaded by a decision support server 7, from data stored in database 9 with which it communicates.

Validation and redemption terminals 11 are in communication with the regional servers 1A . . . 1N. Each of the terminals 11 is comprised of a card reader 13 and preferably a bar code reader 14, smart card reader, or the equivalent, coupled to a printer 15. The card reader is preferably also a card writer for writing the magnetic stripe on a card and/or for updating, debiting or crediting one or more values stored on a smart card (a card which carries a processor or the equivalent and a memory). The term card reader is used in a general sense, since it can include a keypad or keyboard which can be used by the customer and/or merchant. The customer can also or alternatively be identified by a voice identifier, an eye iris reader, a fingerprint reader, a palmprint reader, a keyed-in identity code such as a PIN number, etc. The printer is used to print receipts and coupons, preferably with a bar code. The card reader can be based on the type made by Verifone Corp. for swiping cards and dialing a credit or debit card administration office.

A terminal 11 should be located at the premises of each associated merchant authorized to use the system, and in addition can be located at one or plural arcades 17 or other single or multi-terminal system. A system which can be, but is not limited to arcade 17 which is similar to the system described in the afore noted patent is in communication with a corresponding server, in a manner as will be described later. However, rather than each game 19 communicating directly with a regional server via its own interface, it is preferred that it communicate with a regional server through a master game 21, via shell software which uses a particular communication protocol which can encrypt data. This will be described in more detail later. A database 23 is also coupled to the master game 21.

A computer 25, referred to below as a public PC 25, can be in communication with an associated regional server 1A . . . 1N. Preferably a card reader 13, bar code reader 14 and printer 15 are coupled to the computer, as well as a display 27, keyboard 28, game controls (e.g. a joystick, mouse, trackball, pedals, etc.), a CD ROM player 29, and a DVD (digital versatile disk) player 31.

An administration office 41 contains a computer terminal 43 preferably operating in a Windows™ software environment, with a display 45. Rather than a Windows™ software environment, any type of operating system can be used, such as one which will operate under control of applets downloaded from the internet or any other network, MacIntosh, OS/2, etc. The terminal 43 includes a database and a processor for controlling parameters of software used in the system, and can communicate with the decision support server 7 as will be described below.

In operation, games, advertising and parameters relating to loyalty points and/or coupons are downloaded under control of the decision support server 7 to database 9, then are distributed to regional servers 1A . . . 1N for storage in databases 5A . . . 5N, then are downloaded to database 23 via master game 21. Alternatively the games, parameters and/or advertising are stored at the arcade 17 on local mass storage devices such as hard disk drives, digital versatile disks (DVDs) or CD ROMs (or can be stored in a semiconductor or any other form of mass storage memory), and are enabled from data stored in the decision support software. The games, parameters and/or advertising can be downloaded to the database 23 or can be provided by applet if desired. In the description below, and only for this example, the games and advertising will be described as being stored on DVDs (in database 23 ) at the arcade. The database will be considered for this example to be a combination of the local mass storage and semiconductor memory, but it should be understood that the data can alternatively be downloaded from database 5A . . . 5N coupled to the regional server, and stored for use as needed in the database 23.

It is preferred that the games themselves should be written within a shell, with software “hooks” between the games and shell. The shell should be responsible for starting and stopping the game, altering its parameters, controlling the display of the game that is to be played, and communicating both with other games and with a regional server 1A . . . 1N. It is preferred that each of the games should communicate with the regional server only under control of the master game 21. The software operated by the master game 21 should in addition be designed to communicate with each of the games of the arcade, and with a designated regional server using a communications manager program, in accordance with a predetermined protocol.

Subscriber accounts are retained in the database 9, and are preferably comprised of the following fields:

1. Account data (customer name and PIN),

2. Balance of account (in currency), both current balance and pending balance (the latter being the expected balance after an ongoing transaction has been completed),

3. The identity and value of coupons and premiums allocated to the subscriber,

4. The balance value of loyalty points associated with the customer, e.g. as incremented or decremented by a device such as by an input device at a merchant location (for example by inputting via a keypad connected to the card reader 13 at a validation and redemption terminal 11 ) or by an administrator via terminal 43 at the administration location 41, or by operating an automatic terminal such as a coin telephone having a swipe card reader in administrative communication with regional server 1A to 1N, a game machine, etc.,

5. Game ratings, such as skill level of the subscriber for variously played games, handicap values of the subscriber for variously played games, profiles (e.g. how much time is allocated to the player to complete various games),

6. Viewing history of advertising (e.g. a record of the most recent time that the subscriber has viewed a particular advertisement),

7. Images displayed for this subscriber,

8. The identities of identification cards issued to the player,

9. Merchandise orders, e.g. the identity and loyalty point, premium or currency cost of merchandise that has been ordered, the date ordered, the date the order was sent to the supplier, the date the order was shipped, etc.,

10. The game play history, e.g. for each game played, the rank achieved, number of players in a game or tournament, etc.,

11. Data regarding membership of the customer in competitions or teams,

12. Records of payments of fees made by the customer, and

13. Records of customer premiums and/or prizes awarded (which can be used e.g. for tax computation).

The administrator characterizes each game and activity relating to merchant products and services with certain parameters, and downloads these parameters from terminal 43 to server 7. For example;, the administrator establishes game formulae for each game, loyalty points (or none) for playing each game, for patronizing particular merchants, etc.

When a subscriber is issued an identity (ID) card, a PIN number is issued in a well known manner, and information re its issuance is uploaded from a validation terminal 11 to the associated regional server 1A to 1N. A record in the database 9 relating to this subscriber is established by server 7. The record is seeded by the parameters provided by the administration terminal to the server 7. For example, upon first initiation of the record, a number of loyalty points can be deposited to the subscriber, and recorded in the database in field 4.

The subscriber then pays currency to play say, 5 video games. The payment value is entered by swiping the ID card in a local card reader in the arcade, and by then entering the PIN number of the subscriber and the number of games to be played, or a currency amount into a local keypad. This amount is stored (deposited) in database field 1 (see the above field list) of database 9, after uploading from the arcade 17 via master game 21.

The subscriber then goes to the game and swipes his card in a card reader associated with the game. The request to initiate the game is sent to the game from the card reader, and value of the game play is sent to the decision support server 7. Server 7 addresses database 9, and selects the record of the subscriber from the card number read and provisionally decrements the amount on deposit, storing the resulting pending balance. If the game is not played (e.g. if there is a power outage), the pending balance is again incremented back to the previous balance after a predetermined amount of time. By using a central decision support server 7 and database 9 to store the subscriber accounts, the subscriber can be provided by the service at any location which communicates with any regional server. A duplicate account is established and retained in the regional support server database 5A . . . 5N the records being mutually updated from time to time.

At the time of establishment of the record in database e.g. 5A, the server 7 would also store values in the remaining fields of the record. For example, it would store an advertisement value, to be described in more detail below, in field 6, indicating that no ads have been presented to the subscriber.

After the subscriber has swiped his card at a game, and thus identifies himself, the local database provides a data message to the local system which enables the selected game. If it is the first time the customer has identified himself to the local system, the regional server e.g. 1A sends a data message which enables the selected game. It also enables a DVD to run an advertisement to the game via its shell, which overlays the game in a window, or is presented prior to or with the initial or final screens of the game. For example, the initial screen can be a “welcome to a new player” screen, with an advertisement relating to one or another of the associated merchants. The advertisements to be run are pre-established at the administration terminal 43.

The fact of running a particular advertisement and of the subscriber being located at a particular game (determined from his ID card) is then stored in the 10^{th} field of the record. When the game has been completed, the score is uploaded to the regional server and the rank of the player is established and is stored in the 10^{th} field. The number of plays of the player of that game, and of other games, are also stored in the 10^{th} field. On the basis of this, depending on the administrator, loyalty points, coupons or premiums can be provided to the subscriber.

For example, if the subscriber has achieved a particular score, a predetermined number of loyalty points can be awarded, and added to those in the balance in the 4^{th} field of the database record. A printer 15 can dispense a coupon to the subscriber e.g. for a discount on a food item at a fast food outlet, the serial number and value of which is recorded in the 3^{rd} field of the record. The printout can also record the score and the game that was played.

The identity of the advertisement which was run is recorded in the 6^{th} field of the record.

The subscriber in achieving a particular amount of expertise can be handicapped by the software in the regional server 1A, and the handicap value recorded in the 5^{th} field of the record, the rank achieved recorded in the 10^{th} field, and all of this information can be printed on the same ticket as the coupon, or on another ticket.

Now assume that the player attends a different arcade, and wishes to play a game. He will swipe his ID card in the local card reader, press a button to command the start of a game if necessary, and his identity, a command to play a game and the cost to play is uploaded to the associated regional server, say server 1B. Server 1B searches its database 5B for a record of the identified subscriber, and doesn't find it. It then sends an inquiry to the server 7, which sends an inquiry to each of the other regional servers. Server 1A responds, and provides an indication to server 1B that the subscriber record is stored in a database associated with server 1A.

Server 1A then sends the record of the subscriber to server 1B via server 7. Server 1B checks whether the second field has sufficient balance to pay for the game. On the indication that it does, a provisional decrement is done as described earlier, and server 1B sends a signal to the master game of the arcade to enable the game.

The server 1B also checks the ad view history and image last viewed, and enables the DVD at the arcade to run the next advertisement in the predetermined sequence of advertisements to the game to be played, via the game shell. The entire process is repeated as described earlier.

In the event the customer has used the local system before, and his identity data, etc. is stored in the local database, the above process can be carried out using the data stored in the local database, rather than using the data stored in the server.

The score can result in loyalty points or premiums being awarded to the player, which are stored in the account of the player.

Assume now that the subscriber wishes to redeem loyalty points or premiums. The subscriber can visit a validation and redemption terminal, which can be at the location of a merchant, a public PC, or at an arcade. The ID card of the subscriber is read, and an attendant types in a request on local keyboard such as 28 to obtain the number of loyalty points, or the identities of coupons or premiums held by the subscriber. This request is uploaded to the regional server, which reads the database e.g. 5A and accesses the record of the subscriber identified by the card (and PIN number, if desired). On verification by the regional server, the data stored in the fields of the information requested by the attendant are then downloaded to the local terminal, such as computer 25, and is displayed on display 27.

The customer can ask for redemption of the value of the coupon. For example, if the validation and redemption center is at a fast food outlet, and the coupon is for a discount on a hamburger from the fast food outlet, the merchant can sell the hamburger at the required discount, take the coupon from the subscriber, and key in the coupon on a keypad or read a barcode or magnetic stripe or the equivalent carried by the coupon, to identify it and record it as having been redeemed. The local computer or the equivalent then uploads this data to the regional server 1A, which records that the coupon has been rendered.

While this transaction is going on, there could be a display adjacent the redemption equipment. The regional server, in learning of the presence of the subscriber at that location from the ID card swipe, can then look up the advertisement viewing history from the 6^{th} field of the subscriber's record in the database, and send a control signal to the computer or the equivalent at the redemption center, to enable a local DVD 31 to run the next advertisement in a predetermined sequence to the display which is adjacent the subscriber. Loyalty points can be awarded to the identified subscriber based on viewing a particular advertisement, and stored in the database as described earlier.

In a similar manner, loyalty points can be redeemed. The subscriber can attend a redemption center which can be a merchant, or a special catalog store. After swiping the ID card of the subscriber and keying in a request to display the number of loyalty points accrued to the subscriber, the regional server e.g. 1A accesses the record of the subscriber using his ID and PIN number in database e.g. 5A, and downloads the information to a local display. Following redemption of a particular number of loyalty points for the merchandise or services requested, the 4^{th} field of the record of the subscriber is decremented by the value of the loyalty points redeemed.

It should be noted that the system is global, in that any merchant can have a redemption terminal. Upon redeeming loyalty points which have been accrued by the subscriber by playing games, achieving scores, viewing advertisements, or using services of other merchants, etc. the redeeming merchant can be owed a certain value based on the redemption. This value or the equivalent in loyalty points, can be stored (credited) in a database 5A related to the merchant. When a subscriber purchases goods from that merchant, a certain number of loyalty points can be awarded the subscriber, and the balance debited from the balance of the merchant. Administrator service fees in the form of loyalty points can be accrued to an account of the administrator for each transaction. In this manner, loyalty points become a medium of exchange for the subscriber, the merchants and the administrator.

Loyalty points, or a monetary amount can be decremented from an account of each merchant for each play of its advertisement.

At the end of a predetermined period, for example quarterly, yearly, etc., the administrator and merchants can settle the accounts, e.g. collecting a prescribed monetary value for negative balances of merchant loyalty point accounts, and paying a prescribed monetary value for positive balances of merchant loyalty point accounts.

Loyalty points can also be redeemed by the customer for any merchandise or service at any merchant location or venue at which a service terminal is located, or for game play at an arcade.

Two types of data interchange are preferably used in the system: synchronous and asynchronous. In synchronous interchanges, the client initiates a connection to a server, sends a request, and awaits a reply, in a manner similar to credit card authorizations in retail stores. An example of this type of interchange according to an embodiment of the present invention is the validation of a prize receipt. Asynchronous interchanges are used for database synchronization. They allow events that have been queued by clients to be sent to servers, and allow servers to add or update information in a client's database.

Four modes of communication between clients and servers are preferred to be used:

Queries from clients to servers for specific information,

Events being transmitted from clients to servers,

Record and file system synchronization transmitted from servers to clients, and

Interactive on-line traffic, allowing on-line services in which processing is done in real-time by the server, or through a proxy process on the server.

Because of the short duration and unpredictability of query calls, they are preferably implemented with a point-of-sale, packet type transaction type network, with dial-in connections from various client locations using a global toll-free number.

The remaining types of calls are more predictable in nature and duration, typically lasting one or more minutes, and preferably use full duplex stream-oriented communications. This can be implemented using a dedicated or non-dedicated dial-up line between client and server, using TCP/IP ports (internet or intranet).

Thus each server can initiate two types of connections to client servers: asynchronous dial-in to the transaction network at relatively low speeds (e.g. 2400 baud or higher) for short duration queries, or via a dial-in PPP connection (e.g. 28.8 kbaud or higher) or ISDN to perform sockets-based communication.

The data transmission protocol used is preferred to be bi-directional full-duplex asynchronous communication using X.25-based packet switching, but other communications technologies, e.g. ADSL can be used, as they become widely available. Prior to application to the network, the event data should be packetized, inserted into variable length telecommunication packets, compressed and encrypted using the encryption key of the location. Other fields in the telecommunication packet need not be compressed or encrypted. The received packets should be decrypted, decompressed, and extracted from the telecommunication packets.

The transmissions are preferably initiated from the transmitting entity (dial-in) rather than being polled. The calls can be normal (e.g. to pass data re start, game plays, alarms, meters, etc. to and from the client, stored in a queue at that location for subsequent transmission), urgent (e.g. such as subscriber information when a card is swiped), and receipt validation (e.g. to verify calls used by validation terminals).

Terminals communicating within a single location can use 10 baseT twisted pair wiring and 802.3 (Ethernet™) standard for data link management, or higher speed Ethernet or other technologies, as they become available. The regional servers can accept connections from either the point-of-sale transaction network or from a TCT/IP internet/intranet connection (using Berkeley sockets). The same application-layer protocols operate over each connection, with the possible exception of synchronization, which can operate only over TCP/IP connections, if desired.

The four types of packets referred to above can have a number of subtypes, as follows:

| Packet | Possible Subtypes: | |
|---|---|---|
| Control | Acknowledgment (ACK) | Negative Acknowledgment |
| | | (NAK) |
| | Context Negotiation | Ping |
| | Ping Response | Open Query Link |
| | Close Query Link | Open IP Link |
| | Close IP Link | Link Status Request |
| | Link Status Response | Suspend Processing |
| | Suspend Processing Response | Resume Processing |
| | Resume Processing Response | Synchronize |
| | Synchronize Response | |
| Query | Test | Test Response |
| | Receipt Validation | Receipt Validation Response |
| | Subscriber Information | Subscriber Information |
| | | Response |
| | Account Withdrawal | Account Withdrawal |
| | | Response |
| | Account Deposit | Account Deposit Response |
| | Subscriber Account Data | Subscriber Account Data |
| | Request | Response |
| | Winning Redemption Play | Winning Redemption Play |
| | | Response |
| | Subscriber ID Request | Subscriber ID Response |
| | Credit/Debit Request | Credit/Debit Response |
| | Save State Request | Save State Response |
| | Restore State Request | Restore State Response |
| | New Subscriber Card Request | New Subscriber Card |
| | | Response |
| | Reserve Merchandise | Reserve Merchandise |
| | | Response |
| | Purchase Merchandise | Purchase Merchandise |
| | | Response |
| | Release Merchandise | Release Merchandise |
| | | Response |
| | Subscriber Ranking Request | Subscriber Ranking Response |
| Event | Alarm | Tournament Play |
| | Redemption Play | Meter Readings |
| | Ad Statistics | Service Accesses |
| | Down Times | New Subscriber |
| | New Team | Issued Coupons |
| | Loyalty Point Awards | |
| Synchron- | Inventory | Table Download |
| ization | | |
| | File Initial Download | File Next Download |
| | File Initial Upload | File Next Upload |

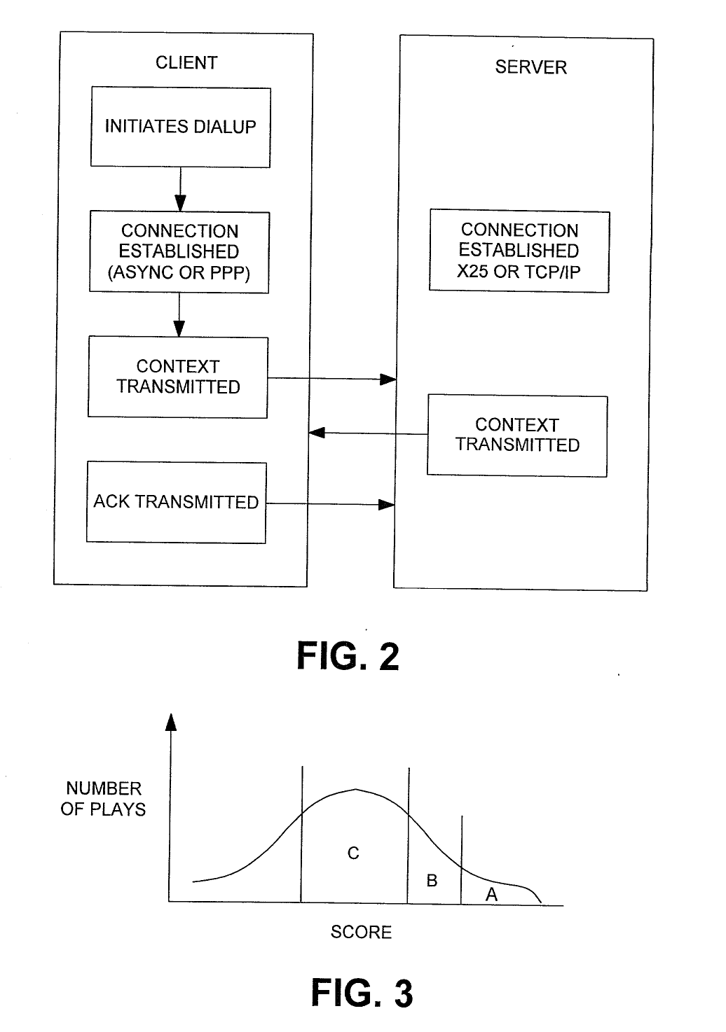

When a call is connected over the point of sale network or either of the TCP/IP ports, the client and server exchange context negotiation packets to configure the session communications as shown in FIG. 2. When both parties have acknowledged the context negotiation, data packets can begin.

The client sends a context negotiation packet with the settings it wishes to use for the call (including the encryption and compression parameters). This packet also tells the server what type of call this is (e.g. events, queries, etc.). The server examines the context negotiation packet and determines whether the values are acceptable. If so, it sends a context negotiation packet with the same settings to the client. The client acknowledges this packet to the server, and the call is considered to be established.

If the server cannot use the context provided by the client, it sends its own context negotiation packet back to the client with its preferred settings (e.g. a “lower” standard for compression or encryption). If the client agrees with these settings, it sends an acknowledgment to the server, and the call is considered to be established.

The contents of the context packet are sent uncompressed, but encrypted using the terminal's 16 byte license key and a TEA encryption algorithm. The terminal cannot operate unless the license key entered at the machine matches the key entered through the server administrative application.

If a device receives a context packet for an encryption method it can perform, it can NAK (unacknowlege) the packet. The server should retransmit session key packets, working from best to worst encryption (retrying a number of times in case of communications faults) until the client returns an acknowledgment. If the client never acknowledges the packet, the server should close the connection. Likewise, if the server never acknowledges the packet from the client, the client can close the connection. The client is free to retry with a new socket on the same call.

When a connection is established over the asynchronous point of sale link, the client may immediately begin transmitting data packets to the server. Then a PPP connection is established, the client should create a socket connection to one of the TCP ports listed above. Packets can then be sent over this socket connection. Multiple socket connections can be opened to allow parallel processing of synchronization, event and query traffic.

Query exchanges preferably occur in lockstep over a single connection. When a terminal issues a query, it waits on the same connection for a matching query response to arrive. The terminal then processes the query response, sends an acknowledgment, then closes the connection or continues with other query exchanges.

If a query initiates the download of table and/or file information to the client, the downloads should take place before the server sends the query response. When the query response is received at the client, it can assume that all downloads are complete.

Event transfer from clients to servers follows a lockstep acknowledgment cycle in which the client sends event packets and the server sends acknowledgment or nonacknowledgment packets in response. Events should remain in the client's event queue until an acknowledgment has been received from the server. When all events have been sent and acknowledged, the client can close the connection.

When a client makes a synchronization call, the client and server begin by exchanging inventory packets. The client sends an inventory of all data currently loaded, and the server sends an inventory of what the client should have (including table records and files).

The client should use the server's inventory to delete all records and files that are not present at the server. The server should use the client's inventory to build a set of table and file download packets to send new information to the client.

Once the inventories have been exchanged, the server should begin sending table and file download packets. The client should respond to these with either an acknowledgment or nonacknowledgement packet. When the server has sent all records, it should send a table download packet with 0 records to indicate the end of data. The client is free to close the connection at this point.

All packets should be framed with a consistent header and trailer, to allow the protocol processor in the receiving server or terminal to distinguish between different versions of requests. A preferred packet is as follows:

| Offset: | Field Size: | Description: |
|---|---|---|
| 0 | I byte | Packet type - the following values are |
| | | defined: |
| | | 0 × 80 = Control Packets |
| | | 0 × 81 = Query Packets |
| | | 0 × 82 = Event Packets |
| | | 0 × 83 = Synchronization Packets |
| | | Note that the high bit is used to distinguish |
| | | these packets from earlier version packets. |
| 1 | I byte | Subtype - the following values are defined: |
| | | Control Packets: |
| | | 0 = Acknowledgment |
| | | 1 = Negative Acknowledgment |
| | | 2 = Context Negotiation |
| | | 3 = Ping |
| | | 4 = Ping Response |
| | | 5 = Open Query Link |
| | | 6 = Close Query Link |
| | | 7 = Open IP Link |
| | | 8 = Close IP Link |
| | | 9 = Request Link Status |
| | | 10 = Link Status Response |
| | | 11 = Suspend Processing |
| | | 11 = Suspend Processing |
| | | 12 = Suspend Processing Response |
| | | 13 = Resume Processing |
| | | 14 = Resume Processing Response |
| | | 15 = Synchronize |
| | | 16 = Synchronize Response |
| | | Query Packets: |
| | | 0 = Test |
| | | 1 = Test Response |
| | | 2 = Receipt Validation |
| | | 3 = Receipt Validation Response |
| | | 4 = Subscriber Information |
| | | 5 = Subscriber Information Response |
| | | 6 = Account Withdrawal |
| | | 7 = Account Withdrawal Response |
| | | 8 = Account Deposit |
| | | 9 = Account Deposit Response |
| | | 10 = Subscriber Account Data Request |
| | | 11 = Subscriber Account Data Response |
| | | 12 = Winning Redemption |
| | | 13 = Winning Redemption Response |
| | | 14 = Subscriber ID Request |
| | | 15 = Subscriber ID Response |
| | | 16 = Credit Debit Request |
| | | 17 = Credit Debit Response |
| | | 18 = Save State Request |
| | | 19 = Save State Response |
| | | 20 = Restore State Request |
| | | 21 = Restore State Response |
| | | 22 = New Subscriber Card Request |
| | | 23 = New Subscriber Card Response |
| | | 24 = Reserve Merchandise |
| | | 25 = Reserve Merchandise Response |
| | | 26 = Purchase Merchandise |
| | | 27 = Purchase Merchandise Response |
| | | 28 = Release Merchandise |
| | | 29 = Release Merchandise Response |
| | | 30 = Subscriber Ranking Request |
| | | 31 = Subscriber Ranking Response |
| | | Event Packets: |
| | | 0 = Alarm |
| | | 1 = Tournament Play |
| | | 2 = Redemption Play |
| | | 3 = Meter Readings |
| | | 4 = Ad Statistics |
| | | 5 = Service Accesses |
| | | 6 = Down Times |
| | | 7 = New Subscriber |
| | | 8 = New Team |
| | | 9 = Issued Coupons |
| | | 10 = Loyalty Point Awards |
| | | Synchronization Packets: |
| | | 0 = Inventory |
| | | 1 = Table Download |
| | | 2 = File Initial Download |
| | | 3 = File Next Download |
| | | 4 = File Initial Upload |
| | | 5 = File Next Upload |
| 2 | 2 bytes | Packet size (in bytes, including the |
| | | type, |
| | | subtype, size and CRC fields), |
| | | LSB first |
| 4 | N bytes | Data (see individual packet description for |
| | | format) |
| 4 + N | 2 bytes | CRC of packet. |

Acknowledgment packets indicate the successful receipt of information. The total size of the framed packet will be 6 bytes.

| Field Size: | Description: |
|---|---|
| 1 byte | Packet Type = 0x80 |
| 1 byte | Packet Subtype = 0x00 |
| 2 bytes | Packet Size = 6 |
| 2 bytes | CRC |

Negative Acknowledgment (NAK)

Negative Acknowledgment packets indicate that a transmission was unsuccessful or that the receiver encountered an error processing the data. The total size of the framed packet will be 7 bytes.

| Field Size: | Description: |
|---|---|
| 1 byte | Packet Type = 0x80 |
| 1 byte | Packet Subtype = 0x01 |
| 2 bytes | Packet Size = 7 |
| 1 byte | Failure Code |
| | 0 Generic failure |
| | 1 System error |
| | 2 Allocation failure |
| | 3 Invalid Request |
| | 4 Communications error |
| 2 bytes | CRC |

Context Negotiation

Context Negotiation packets have the following data structure:

| Field Size: | Description: |
|---|---|
| 1 byte | Packet type = 0x80 |
| 1 byte | Packet Subtype = 0x02 |
| 2 bytes | Packet Size = 40+ |
| 4 bytes | Location ID (LSB first) |
| 6 bytes | Terminal ID |
| [BEGIN ENCRYPTED AREA] | |
| 16 bytes | License Key |
| 1 byte | Connection type |
| 1 byte | Encryption type |
| 1 byte | Transmission Sequencing |
| 2 bytes | Key Length (in bytes, LSB first) |
| N bytes | Key Data |
| (Pad encrypted area to even 8-byte boundary with zeros) | |
| [END ENCRYPTED AREA] | |
| 2 bytes | CRC |

Location ID will be 0 in packets from the client. It will be filled in with packets from the server with the location ID configured for the terminal ID from the client, or 0 if the terminal is not configured in any location. Terminals that are not configured in any location can still access the server for some limited functions. However, if the licensing information is not correct, the server will never send a Context Negotiation packet to the client.

The licence key is a value entered through the user interface at the terminal, and entered by the operator when configuring the machine in the administrative application. It is used to encrypt the encrypted area of the Context Negotiation packet. When the packet is received, the receiving node decrypts the encrypted area with its stored license key, then compares that key with the decrypted version from the packet. If the two do not match, the machine is not licensed correctly and the Context Negotiation will not succeed until this is corrected. At the terminal, a message indicating incorrect license information should be displayed or printed. At the server, the event will be logger for reporting and/or alarming.

The connection type will be one of the packet types codes (0×80 through 0×83) indicating the type of connection being made. This will indicate to the server which protocol processor to launch for the connection. Note that if more that one type of activity needs to occur one connection, the client can send a Context Negotiation packet during the call to renegotiate the call type (and other parameters of the connection as well.) When this occurs, all in-progress operations are completed then renegotiation occurs.

The Encryption type field will be one of the following values:

| Value | Description |
|---|---|
| 0 | No encryption |
| 1 | XOR of key and plain text |
| 2 | Earlier Protocol Version encryption |
| 3 | TEA (see Appendix A for algorithm) |
| 4 | IDEA |
| 5 | RSA |

Transmission sequencing will be one of the values below:

| Value | Description |
|---|---|
| 0 | Lockstep (send packet, wait for Ack, |
| | send next packet) |

The contents of the key data will depend on the Encryption type as shown here:

| Encryption | Key Length and |
|---|---|
| Type: | Key Data: |
| 0 | data will be included |
| 1 | Key length will be 0, and no |
| 2 | Key length and key data can vary |
| 3 | Key length and key data can vary |
| 4 | Key length is 16, key data can vary |
| 5 | Key length is 5, key data can vary |

Key length and key data can vary

For connections between terminals within a single location, or between processes on a single terminal, the terminal ID and location ID are both set to 0. The contents of the packet will not be encrypted and should have the following values:

Encryption type=0

Transmission Sequencing=0

Key length=0

This type of connection is only valid on LAN segments or between processes on a single machine.

The license key field will be filled by the terminal's license key. This allows the server process to enforce unique license keys and prevent services from establishing their own connections to the server without their own valid license keys.

Ping

Ping packets are used to test communications to the server. The total size of the framed packet will be 6 bytes.

| Field Size: | Description: |
|---|---|
| 1 byte | Packet Type = 0x80 |
| 1 byte | Packet Subtype = 0x03 |
| 2 bytes | Packet Size = 6 |
| 2 bytes | CRC |

Upon receipt of a Ping packet, the server will immediately generate a Ping Response packet and send it to the client. This does not require any database or file system access, and can be used to test the basic connection between client and server processes.

Ping Response

Ping Response packets are sent in reply to a Ping packet. The total size of the framed packet will be 6 bytes.

| Field Size: | Description: |
|---|---|
| 1 byte | Packet Type = 0x80 |
| 1 byte | Packet Subtype = 0x04 |
| 2 bytes | Packet Size = 6 |
| 2 bytes | CRC |

Open Query Link

A request that a link to the server be created that is capable of supporting query traffic (or increases the reference count of an existing link). The total size of the framed packet will be 6 bytes.

| Field Size: | Description: |
|---|---|
| 1 byte | Packet Type = 0x80 |
| 1 byte | Packet Subtype = 0x05 |
| 2 bytes | Packet Size = 6 |
| 2 bytes | CRC |

This operation is intended for use between slave and master terminals within a location or between processes on a single terminal. On receipt of this packet, the recipient should establish a connection to the server suitable for query traffic. This may mean forwarding a similar request to the next higher server in the hierarchy.

If there is already a link established, its reference count is incremented.

Close Query Link

A request that a link to the server established by an Open Query Link request be closed (or the reference count of the link be decremented). The total size of the framed packet will be 6 bytes.

| Field Size: | Description: |
|---|---|
| 1 byte | Packet Type = 0x80 |
| 1 byte | Packet Subtype = 0x06 |
| 2 bytes | Packet Size = 6 |
| 2 bytes | CRC |

Open IP Link

A request that a link to the server be created that is capable of supporting IP traffic (or increases the reference count of an existing link.) The total size of the framed packet will be 6 bytes.

| Field Size: | Description: |
|---|---|
| 1 byte | Packet Type = 0x80 |
| 1 byte | Packet Subtype = 0x07 |
| 2 bytes | Packet Size = 6 |
| 2 bytes | CRC |

This operation is intended for use between slave and master terminals within a location or between processes on a single terminal. On receipt of this packet, the recipient should establish a connection to the server suitable for all types of traffic. This may mean forwarding a similar request to the next higher server in the hierarchy.

If there is already a capable link established, its reference count is incremented.

Close IP Link

A request that a link to the server established by an Open IP Link request be closed (or the reference count to the link be decremented). The total size of the framed packet will be 6 bytes.

| Field Size: | Description: |
|---|---|
| 1 byte | Packet Type = 0x80 |
| 1 byte | Packet Subtype = 0x08 |
| 2 bytes | Packet Size = 6 |
| 2 bytes | CRC |

Request Link Status

A request for the current link status. The total size of the framed packet will be 6 bytes.

| Field Size: | Description: |
|---|---|
| 1 byte | Packet Type = 0x80 |
| 1 byte | Packet Subtype = 0x09 |
| 2 bytes | Packet Size = 6 |
| 2 bytes | CRC |

When a server receives this request, it should respond with the status of the link to the main ADMIN server group. This may mean forwarding a similar request to the next higher server in the hierarchy.

Link Status

Returns to the current link status. Sent in response to a Request Link Status packet. The total size of the framed packet will be 6 bytes.

| Field Size: | Description: |
|---|---|
| 1 byte | Packet Type = 0x80 |
| 1 byte | Packet Subtype = 0x0A |
| 2 bytes | Packet Size = 7 |
| 1 byte | Link Status |

Low order nibble is current link status

| | |
|---|---|
| 0x00 | Link state unknown (indicates an error) |
| 0x01 | Link is idle |
| 0x02 | Connecting asynchronous |
| 0x03 | Connecting asynchronous, IP request |
| | pending |
| 0x04 | Connecting IP |
| 0x05 | Connected asynchronous |
| 0x06 | Connected asynchronous, IP request |
| | pending |
| 0x07 | Connected IP |

High order nibble is modem state (if applicable)

| | |
|---|---|
| 0x00 | Modem idle (or no modem in link) |
| 0x10 | Modem is dialing |
| 0x20 | Modem is waiting for answer |
| 0x30 | Modem is connected |
| 0x40 | Modem is authenticating |

High bit indicates processing is suspended

| | |
|---|---|
| 0x80 | Processing suspended |

| | |
|---|---|
| 1 byte | Query Status |

High bit is one if a query is in progress
Bits 0-6 indicate the percentage complete

| | |
|---|---|
| 1 byte | Event Status |

High bit is one if an event exchange is in
progress
Bits 0-6 indicate the percentage complete

| | |
|---|---|
| 1 byte | Synchronization Status |

High bit is one if a database synchronization is
in progress
Bits 0-6 indicate the percentage complete

| | |
|---|---|
| 2 bytes | CRC |

The fields in the response packet relating to query, event and synchronization status are relevant only when the server process is running on a master terminal within a location. All other servers will return 0 for these three fields.

Suspend Processing

Requests that the communications process on the master terminal suspend any activity that could impact system performance. This prevents service degradation to ensure fair tournament play. The total size of the framed packet will be 10 bytes.

| Field Size: | Description: |
|---|---|
| 1 byte | Packet Type = 0x80 |
| 1 byte | Packet Subtype = 0x0B |
| 2 bytes | Packet Size = 10 |
| 4 bytes | Time-out (seconds) |
| 2 bytes | CRC |

Suspect Processing Response

Sent by the communications process on a master terminal in response to a Suspend Processing request packet, indicating that the processing will be suspended as soon as possible. The client can use Get Link Status to determine when processing has been suspended. The total size of the framed packet will be 6 bytes.

| Field Size: | Description: |
|---|---|
| 1 byte | Packet Type = 0x80 |
| 1 byte | Packet Subtype = 0x0C |
| 2 bytes | Packet Size = 6 |
| 2 bytes | CRC |

Resume Processing

Informs the communications process on a master terminal that normal processing can be resumed. This should be performed after a time-critical operation has completed, and should balance each Suspend Processing packet. The total size of the framed packet will be 6 bytes.

| Field Size: | Description: |
|---|---|
| 1 byte | Packet Type = 0x80 |
| 1 byte | Packet Subtype = 0x0D |
| 2 bytes | Packet Size = 6 |
| 2 bytes | CRC |

Resume Processing Response

Sent by the communications process on a master terminal in response to a Resume Processing request packet, indicating that normal processing will be resumed. The total size of the framed packet will be 6 bytes.

| Field Size: | Description: |
|---|---|
| 1 byte | Packet Type = 0x80 |
| 1 byte | Packet Subtype = 0x0E |
| 2 bytes | Packet Size = 6 |
| 2 bytes | CRC |

Synchronize

Requests that the communications process on a master terminal initiate a synchronization with its server. Different levels of synchronization can be requested in the flags field. Note that the communications process should perform a full synchronization on startup and again every few hours automatically (depending on the dial in interval configured for the location). The total size of the framed packet will be 7 bytes.

| Field Size: | Description: |
|---|---|
| 1 byte | Packet Type = 0 × 80 |
| 1 byte | Packet Subtype = 0 × 0F |
| 2 bytes | Packet Size = 7 |
| 1 byte | Flags |
| | Defined bits include: |
| | 0 × 01 Scan file system and update |
| | W_CONTENT_CACHE table |
| | 0 × 02 Synchronize the database with the server |
| | 0 × 04 Synchronize subscriber records in cache |
| | 0 × FF Do full synchronization |
| 2 bytes | CRC |

Synchronize Response

Sent by the communications process on the master terminal in response to a Synchronize packet, indicating that the process will begin the synchronization as soon as possible. The total size of the framed packet will be 6 bytes.

| Field Size: | Description: |
|---|---|
| 1 byte | Packet Type = 0x80 |
| 1 byte | Packet Subtype = 0x10 |
| 2 bytes | Packet Size = 6 |
| 1 byte | Packet Type = 0x80 |
| 1 byte | Packet Subtype = 0x10 |
| 2 bytes | Packet Size = 6 |
| 2 bytes | CRC |

Receipt Validation

Receipt validation packets are traditionally sent by validation terminals, but can be sent by any authorized terminal. Receipt IDs are printed on all receipts or coupons generated at terminals. The receipt ID is printed in two formats—a bar-code symbol using the Code 39 symbology, and a 15-digit numerical string, printed in 5 groups of 3 digits.

This packet is also used to redeem receipts and loyalty points the subscriber has on account. This is typically done by game terminals, following a Subscriber Account Information query to gather the current account information.

Receipt validation packets have the following data structure:

| Field Size: | Description: |
|---|---|
| 1 byte | Packet Type = 0 × 81 |
| 1 byte | Packet Subtype = 0 × 02 |
| 2 bytes | Packet Size = 30 |
| [BEGIN ENCRYPTED AREA] | |
| 6 bytes | Validating Terminal ID |
| 1 byte | Receipt ID length (10 or 15) |
| N bytes | Receipt ID |
| (Pad encrypted area to even 8-byte boundary with zeros) | |
| [END ENCRYPTED AREA] | |
| 2 bytes | CRC |

The length of the receipt data governs its format. The formats supported, and their lengths, are shown here:

| Length: | Format: |
|---|---|
| 10 | 10 Code-39 Bar-code symbols, as read from the |
| | printed receipt |
| 14 | 4-byte value representing the loyalty program ID |
| | 4-byte value representing the number of points |
| | being redeemed |
| | 4-byte value representing the subscriber ID |
| | 2-byte value representing the PIN |
| 15 | 15 decimal digits, as printed on the receipt |
| 16 | 10 Code-39 Bar-code symbols, as read from the |
| | printed coupon |
| | 4-byte value representing the subscriber ID |
| | 2-byte value representing the PIN |
| 21 | 15 digit receipt ID of coupon being redeemed |
| | 4-byte value representing the subscriber ID |
| | 2-byte value representing the PIN |

The receipt ID should appear in the packet in the same order as entered or scanned from the receipt. For numeric IDs, send the ASCII code for each digit. For bar-code format, send the ASCII codes for the bar-code symbols as defined in the Code 39 bar-code symbology.

Receipt Validation Response

When the server receives a Receipt Validation query, it will attempt to validate the receipt ID in the packet, and will return this response packet with the results.

Receipt validation response packets have the following data structure:

| Field Size: | Description: |
|---|---|
| 1 byte | Packet Type = 0 × 81 |
| 1 byte | Packet Subtype = 0 × 03 |
| 2 bytes | Packet Size = 14 or 22 |
| [BEGIN ENCRYPTED AREA] | |
| 1 byte | Status indicator |
| | 0 = Coupon valid-payment authorized |
| | 1 = Coupon not found on server |
| | 2 = System error |
| | 3 = Coupon already redeemed |
| | 4 = Insufficient loyalty points |
| | 5 = Invalid loyalty program |
| | 6 = Subscriber not found |
| | 7 = Invalid PIN |
| | 8 = Subscriber account frozen |
| 15 bytes | Authorization code (only present if |
| | status = 0) |
| (Pad encrypted area to even 8-byte boundary with zeros) | |
| [END ENCRYPTED AREA] | |
| 2 bytes | CRC |

The authorization code will be an ASCII string consisting of digits only. It will always contain 15 digits.

Subscriber Information

Subscriber information queries are sent by clients when a subscriber logs on to a terminal and that subscriber's information is not in the local database cache. This query will cause table and file downloads between the query and the response.

Subscriber information request packets have the following data structure:

| Field Size: | Description: |
|---|---|
| 1 byte | Packet Type = 0 × 81 |
| 1 byte | Packet Subtype = 0 × 04 |
| 2 bytes | Packet Size = 38 |
| [BEGIN ENCRYPTED AREA] | |
| 6 bytes | Terminal ID requesting the information |
| 1 byte | Card type used in the request |
| | 1 = ADMIN card |
| | 2 = Credit card |
| | 3 = Debit card |
| | 4 = Name |
| | 5 = Name and SSN |
| 16 bytes | Card data |
| 2 bytes | PIN |
| (Pad encrypted area to even 8-byte boundary with zeros) | |
| [END ENCRYPTED AREA] | |
| 2 bytes | CRC |

If the card type is 1 (ADMIN Cards), the card data should be filled with the 10-digit ID read from the NANI card followed by 6 spaces.

If the card type is 2 or 3 (Credit or Debit card), the card data field should be the data read from the PAN field on the card stripe (either track or track 2).

If the card type is 4 (Name), the card data field should be filled with 14 characters of the player's name followed by 2 spaces.

If the card type is 5 (Name and SSN), the card data field should be filled with 10 characters of the player's name followed by a 4-byte representation of the players SSN (treated as an integer, stored LSB first), followed by 2 spaces. This is the only case in which non-ASCII data is stored in the card data field.

Subscriber Information Response

When the server received a request for subscriber information, it will collect the information about the subscriber (if found) into table and file download packets, and transmit them to the client. When all downloads are complete, this response packet will be sent to the client. If there is an error or if the subscriber is not found in the server's database, this response will be transmitted right away.

Subscriber information response packets have the following data structure:

| Field Size: | Description: |
|---|---|
| 1 byte | Packet Type = 0 × 81 |
| 1 byte | Packet Subtype = 0 × 05 |
| 2 bytes | Packet Size = 14 or 22 |
| [BEGIN ENCRYPTED AREA] | |
| 6 bytes | Terminal ID requesting the information |
| 1 byte | Status Indicator |
| | 0 = Information found-subscriber valid |
| | 1 = Information not found |
| | 2 = System error |
| | 3 = Invalid PIN |
| 4 bytes | Subscriber ID (only present if status = 0) |
| (Pad encrypted area to even 8-byte boundary with zeros) | |
| [END ENCRYPTED AREA] | |
| 2 bytes | CRC |

If status is 0 or 3, this packet will be preceded by a one or more table and/or file download packets containing the subscriber information. When the response packet is received, all subscriber data will have been downloaded to the terminal. Responses with status codes 1 or 2 will be returned right away.

Account Withdrawal

This query is sent by clients when a subscriber requests a withdrawal of money currently on account.

Account withdrawal packets have the following data structure:

| Field Size: | Description: |
|---|---|
| 1 byte | Packet Type = 0 × 81 |
| 1 byte | Packet Subtype = 0 × 06 |
| 2 bytes | Packet Size = 22 |
| [BEGIN ENCRYPTED AREA] | |
| 6 bytes | Terminal ID requesting the transaction |
| 4 bytes | Subscriber ID |
| 2 bytes | PIN number entered by subscriber |
| 4 bytes | Amount to be withdrawn (in US cents) |
| (Pad encrypted area to even 8-byte boundary with zeros) | |
| [END ENCRYPTED AREA] | |
| 2 bytes | CRC |

The server will enforce limits on the maximum and minimum amounts for which a withdrawal can be made.

Account Withdrawal Response

When an account withdrawal request is made, the server will attempt to perform the withdrawal, then will send this response packet to the client with the results. Account withdrawal response packets have the following data structure:

| Field Size: | Description: |
|---|---|
| 1 byte | Packet Type = 0 × 81 |
| 1 byte | Packet Subtype = 0 × 07 |
| 2 bytes | Packet Size = 22 or 38 |
| [BEGIN ENCRYPTED AREA] | |
| 6 bytes | Terminal ID performing the withdrawal |
| 4 bytes | Subscriber ID |
| 1 byte | Status indicator |
| | 0 = Withdrawal authorized |
| | 1 = Insufficient funds |
| | 2 = Subscriber not found on server |
| | 3 = Invalid PIN |
| | 4 = Account frozen |
| | 5 = System error |
| | 6 = Invalid amount |
| 15 bytes | Authorization ID for withdrawal (only |
| | present if status 0) |
| 4 bytes | New account balance, in US cents (only |
| | present if status = 0) |
| (Pad encrypted area to even 8-byte boundary with zeros) | |
| [END ENCRYPTED AREA] | |
| 2 bytes | CRC |

Account Deposit

This query is sent by the clients when a subscriber requests a deposit of money to his or her own ADMIN account.

Account deposit packets have the following data structure:

| Field Size: | Description: |
|---|---|
| 1 byte | Packet Type = 0 × 81 |
| 1 byte | Packet Subtype = 0 × 08 |
| 2 bytes | Packet Size = 22 |
| [BEGIN ENCRYPTED AREA] | |
| 6 bytes | Terminal ID requesting the transaction |
| 4 bytes | Subscriber ID |
| 2 bytes | PIN number entered by subscriber |
| 4 bytes | Amount to be deposited (in US cents) |
| [END ENCRYPTED AREA] | |
| 2 bytes | CRC |

Account Deposit Response

When an account deposit request is made, the server will attempt to perform the deposit, then will send this response packet to the client with the results.

Account deposit response packets have the following data structure:

| Field Size: | Description: |
|---|---|
| 1 byte | Packet Type = 0 × 81 |
| 1 byte | Packet Subtype = 0 × 09 |
| 2 bytes | Packet Size = 22 or 38 |
| [BEGIN ENCRYPTED AREA] | |
| 6 bytes | Terminal ID performing the withdrawal |
| 4 bytes | Subscriber ID |
| 1 byte | Status indicator |
| | 0 = Deposit accepted |
| | 1 = Account limit exceeded |
| | 2 = Subscriber not found on server |
| | 3 = Invalid PIN |
| | 4 = Account frozen |
| | 5 = System error |
| | 6 = Invalid amount |
| 15 bytes | Authorization ID for deposit (only present |
| | if status = 0) |
| 4 bytes | New account balance, in US cents (only |
| | present if status = 0) |

| (Pad encrypted area to even 8-byte boundary with zeros) | |
|---|---|
| [END ENCRYPTED AREA] | |
| 2 bytes | CRC |

Subscriber Account Data Request

This query is sent by clients when a subscriber requests a full report on his or her current account status.

Subscriber account data request packets have the following data structure:

| Field Size: | Description: |
|---|---|
| 1 byte | Packet Type = 0x81 |
| 1 byte | Packet Subtype = 0x0A |
| 2 bytes | Packet Size = 22 |
| [BEGIN ENCRYPTED AREA] | |
| 6 bytes | Terminal ID |
| 4 bytes | Subscriber ID |
| 2 bytes | PIN |
| (Pad encrypted area to even 8-byte boundary with zeros) | |
| [END ENCRYPTED AREA] | |
| 2 bytes | CRC |

Subscriber Account Data Response

When the server received an account data request, it collects the information about the subscriber's account and sends this response packet.

Subscriber account data response packets have the following data structure:

| Field Size: | Description: |
|---|---|
| 1 byte | Packet Type = 0x81 |
| 1 byte | Packet Subtype = 0x0B |
| 2 bytes | Packet Size = 22 or 38+ |
| [BEGIN ENCRYPTED AREA] | |
| 6 bytes | Terminal ID |
| 4 bytes | Subscriber ID |
| 1 byte | Status Indicator |
| | 0 = Success |
| | 1 = Account Frozen |
| | 2 = Subscriber not found |
| | 3 = Invalid PIN |
| | 4 = System error |
| 4 bytes | Account balance (in US cents) (on success) |
| 4 bytes | Amount withdrawn pending confirmation (in US |
| | cents) (on success) |
| 2 bytes | Number of outstanding orders (on success) |
| 6 bytes | Order ID (on success) |
| 40 bytes | Item name (on success) |
| 4 bytes | Date and time order received (on success) |
| 4 bytes | Date and time order sent to supplier (on |
| | success) |
| 4 bytes | Expected ship date and time (on success) |
| 4 bytes | Date and time order shipped (on success) |
| 4 bytes | Date and time order canceled (on success) |
| 2 bytes | Number of coupons (on success) |
| 4 bytes | Coupon ID (on success) |
| 40 bytes | Description (on success) |
| 6 bytes | Receipt ID (on success) |
| 4 bytes | Face value (on success) |
| 4 bytes | Expiration date (on success) |
| 2 bytes | Number of loyalty programs (on success) |
| 4 bytes | Loyalty program ID (on success) |
| 40 bytes | Loyalty program name (on success) |
| 20 bytes | Loyalty point label (on success) |
| 4 bytes | Number of points (on success) |
| (Pad encrypted area to even 8-byte boundary with zeros) | |
| [END ENCRYPTED AREA] | |
| 2 bytes | CRC |

Winning Redemption Play

When a redemption game has been played that awards a prize, and the prize has a limited number of units available (a non-zero value for the NUM_REMAINING field in the database), or that wins a prize that includes a pool amount, the terminal should immediately issue this query to update its local prize information.

This packet permits prize pools to be maintained across several locations, without the chance that more prizes that are available will be given out. It also allows the server to update the local pool value so players can see pool contributions from multiple locations.

Winning redemption play packets have the following data structure:

| Field Size: | Description: |
|---|---|
| 1 byte | Packet Type = 0x81 |
| 1 byte | Packet Subtype = 0x0C |
| 2 bytes | Packet Size = 38+ |
| [BEGIN ENCRYPTED AREA] | |
| 4 bytes | Subscriber ID playing the redemption game (LSB |
| | first) |
| 6 bytes | Terminal ID on which the redemption game was |
| | played |
| 4 bytes | Service ID on which redemption game was played |
| | (LSB first) |
| 1 byte | Player Station (8 bit flags, position 0 = station |
| | 1, etc.) |
| 1 byte | Active Stations (8 bit flags, position 0 = |
| | station 1, etc.) |
| 4 bytes | Start Date and Time (UTC format, LSB first) |
| 4 bytes | End Date and Time (UTC format, LSB first) |
| 1 byte | Flags |
| | 0x01 Equipment failed during game |
| | 0x02 Score is invalid |
| 1 byte | Number of statistics (n) |
| [BEGIN REPEATING LIST] | |
| 4 bytes | Statistic ID (LSB first) |
| 4 bytes | Statistic Value (LSB first) |
| [END REPEATING LIST] | |
| 1 byte | Number of redemption games entered with the play |
| | (m) |
| [BEGIN REPEATING LIST] | |
| 4 bytes | Redemption ID (LSB first) |
| 2 bytes | Par level beaten (LSB first) |
| 4 bytes | Par score beaten (LSB first) |
| 4 bytes | Derived score achieved by subscriber (LSB |
| | first) |
| 4 bytes | Prize ID awarded (LSB first) |
| [END REPEATING LIST] | |
| (Pad encrypted area to even 8-byte boundary with zeros) | |
| [END ENCRYPTED AREA] | |
| 2 bytes | CRC |

The subscriber ID may be 0 if the redemption game is unidentified.

Winning Redemption Play Response

When a winning redemption play query is received at the server, it will adjust the number of the awarded prizes remaining (if that number is limited), and/or it will calculate the pool amount to award to the player based on the current value of the collective prize pool. (If the par level has an associated pool amount). It will send this response packet back to the terminal, indicating the amount of the pool the player should be awarded and updating the pool value and number of prizes remaining as appropriate.

Winning redemption play response packets have the following data structure:

| Field Size: | Description: |
|---|---|
| 1 byte | Packet Type = 0x81 |
| 1 byte | Packet Subtype = 0x0D |
| 2 bytes | Packet Size = 14+ |
| [BEGIN ENCRYPTED AREA] | |
| 4 bytes | Current pool value (LSB first) |
| 1 byte | Number of par levels being updated (n) |
| [BEGIN REPEATING LIST] | |
| 4 bytes | Redemption ID being updated (LSB |
| | first) |
| 2 bytes | Par level being updated (LSB first) |
| 4 bytes | New pool value (after award) (LSB |
| | first) |
| 4 bytes | Pool amount to award (LSB first) |
| 4 bytes | Number of prizes remaining (LSB |
| | first) |
| [END REPEATING LIST] | |
| (Pad encrypted area to even 8-byte boundary with zeros) | |
| [END ENCRYPTED AREA] | |
| 2 bytes | CRC |

Subscriber ID Request

A subscriber ID request is used when a terminal needs to register a new player who does not have a NANI card. It generates a unique, unassigned subscriber ID that the player's card data can be associated with.

Subscriber ID request packets have no data. The packet header is sufficient to convey the request.

| Field Size: | Description: |
|---|---|
| 1 byte | Packet Type = 0x81 |
| 1 byte | Packet Subtype = 0x0E |
| 2 bytes | Packet Size = 6 |
| 2 bytes | CRC |

Subscriber ID Response

Upon completion, this request will have registered this ID as “allocated but unassigned”. When the player registers, the terminal should send in a New Subscriber Event to assign the ID to the player.

Subscriber ID response packets have the following data structure:

| Field Size: | Description: |
|---|---|
| 1 byte | Packet Type = 0x81 |
| 1 byte | Packet Subtype = 0x0F |
| 2 bytes | Packet Size = 14 |
| [BEGIN ENCRYPTED AREA] | |
| 1 byte | Status Code |
| | 0 = Success |
| | 1 = Failure |
| 4 bytes | Subscriber ID (only present on success) |
| (Pad encrypted area to even 8-byte boundary with zeros) | |
| [END ENCRYPTED AREA] | |
| 2 bytes | CRC |

Credit/Debit Request

This request is issued by a terminal when a player presents a credit or debit card and requests that money be transferred on to the terminal for play, or into the player's account.

Credit/debit request packets have the following data structure:

| Field Size: | Description: |
|---|---|
| 1 byte | Packet Type = 0x81 |
| 1 byte | Packet Subtype = 0x10 |
| 2 bytes | Packet Size = 46 |
| [BEGIN ENCRYPTED AREA] | |
| 6 bytes | Terminal ID requesting the transaction |
| 4 bytes | Subscriber ID |
| 2 bytes | PIN (LSB first) |
| 1 byte | Card format (FC from track 1 stripe) |
| 16 bytes | Card data (PAN code from track 1 stripe) |
| 4 bytes | Expiration date (4 bytes of addition data |
| | from track 1 stripe) |
| 2 bytes | Debit PIN (LSB first, zero for credit |
| | cards) |
| 4 bytes | Amount to be withdrawn (in US cents, LSB |
| | first) |
| 1 byte | Disposition |
| | 0 = Place in subscriber account |
| | 1 = Credit local terminal |
| (pad encrypted area to even 8-byte boundary with zeros) | |
| [END ENCRYPTED AREA] | |
| 2 bytes | CRC |

The card format, card data and expiration date fields should all appear exactly as read from the magnetic stripe on the card. The PIN should be entered by the player for debit cards only.

Credit/Debit Response

When a credit/debit request is received at the server, it will validate the player's subscriber information and eligibility to perform this type of request, then will attempt to authenticate the request through a credit processing system. Finally, it will transmit this response packet to the terminal with the results.

Credit/Debit response packets have the following structure:

| Field Size: | Description: |
|---|---|
| 1 byte | Packet Type = 0x81 |
| 1 byte | Packet Subtype = 0x11 |
| 2 bytes | Packet Size = 22 or 46 |
| [BEGIN ENCRYPTED AREA] | |
| 6 bytes | Terminal ID performing the transaction |
| 4 bytes | Subscriber ID |
| 1 byte | Status indicator |
| | 0 = Credit approved |
| | 1 = Invalid card |
| | 2 = Credit limit exceeded |
| | 3 = Account would exceed limit |
| | 4 = Account frozen |
| | 5 = Invalid amount |
| | 6 = Invalid PIN |
| | 7 = Subscriber not found |
| | 8 = System error |
| 1 byte | Disposition (only present if status = 0) |
| | 0 = Placed in subscriber account |
| | 1 = Credit local terminal |
| 4 bytes | Amount (only present of status = 0) |
| 15 bytes | Authorization ID for the transaction (only |
| | present if status = 0) |
| 4 bytes | New account balance (only present if |
| | status = 0) |
| (Pad encrypted area to even 8-byte boundary with zeros) | |
| [END ENCRYPTED AREA] | |
| 2 bytes | CRC |

The terminal ID and subscriber ID will be copied from the request packet, to verify that the response matches the request. The authorization ID will consist of 15 ASCII digits.

Save State Request

This request is used when a player wants to save the state of a game or other service (including the user interface shell) for later restoration (on this or another terminal).

Save State request packets have the following data structure:

| Field Size: | Description: |
|---|---|
| 1 byte | Packet Type = 0x81 |
| 1 byte | Packet Subtype = 0x12 |
| 2 bytes | Packet Size = 46 |
| [BEGIN ENCRYPTED AREA] | |
| 6 bytes | Terminal ID on which the state is being |
| | saved |
| 4 bytes | Subscriber ID |
| 2 bytes | PIN |
| 4 bytes | Service ID |
| 1 byte | Slot Number |
| 20 bytes | Save State Name |
| (Pad encrypted area to even 8-byte boundary with zeros) | |
| [END ENCRYPTED AREA] | |
| 2 bytes | CRC |

This packet is sent to the server to obtain a File ID. That file ID can then be used to upload the save state file to the server.

Save State Response

When the server receives a save state request packet, it allocates a file ID for the save state and returns the ID to the terminal in this response packet. It also provides the terminal with a pathname that the terminal should move the file to. This will ensure the integrity of the subscriber cache.

Save State response packets have the following data structure:

| Field Size: | Description: |
|---|---|
| 1 byte | Packet Type = 0x81 |
| 1 byte | Packet Subtype = 0x13 |
| 2 bytes | Packet Size = 22 |
| [BEGIN ENCRYPTED AREA] | |
| 6 bytes | Terminal ID on which the state is being |
| | saved |
| 4 bytes | Subscriber ID |
| 1 byte | Status Indicator |
| | 0 = Ready for upload |
| | 1 = Account storage allocation |
| | exceeded |
| | 2 = Subscriber not found on server |
| | 3 = Invalid PIN |
| | 4 = Service not found on server |
| | 5 = Account frozen |
| | 6 = System error |
| 4 bytes | File ID (only present if status = 0) |
| 60 bytes | Local pathname (only present if status = 0) |
| (Pad encrypted area to even 8-byte boundary with zeros) | |
| [END ENCRYPTED AREA] | |
| 2 bytes | CRC |

The terminal ID and subscriber ID will be copied from the request packet, to verify that the response matches the request.

The terminal is then free to use the file upload protocol to send the file.

Restore State Request

This request is issued when a player wants to restore a state that was saved previously on this or another terminal. The server will return the File ID of the save state file, and if the download flag indicates a download is required, it will download the save state file between the request and the response.

Restore State request packets have the following data structure:

| Field Size: | Description: |
|---|---|
| 1 byte | Packet Type = 0 × 81 |
| 1 byte | Packet Subtype = 0 × 14 |
| 2 bytes | Packet Size = 30 |
| [BEGIN ENCRYPTED AREA] = 17 | |
| 6 bytes | Terminal ID on which the state is being |
| | restored |
| 4 bytes | Subscriber ID |
| 2 bytes | PIN |
| 4 bytes | Service ID |
| 1 byte | Slot number |
| 1 byte | Download flag |
| | 0 = Do not download the save state file |
| | 1 = Download the file if it exists |
| (Pad encrypted area to even 8-byte boundary with zeros) | |
| [END ENCRYPTED AREA] | |
| 2 bytes | CRC |

Even if the file exists on the local machine, this request should be made before the player is allowed to load it, to assure the player is authenticated as the owner of the data, and also to verify the File ID of the save state file as stored in the SUBSCRIBER_SAVE_STATE table.

Restore State Response

When the server received a restore state request, it will search for the saved state data, validate the integrity of the file, and return the file ID to the client. If the client requested a download of the file, the file will be transmitted before the response is returned.

Restore State response packets have the following data structure:

| Field Size: | Description: |
|---|---|
| 1 byte | Packet Type = 0 × 81 |
| 1 byte | Packet Subtype = 0 × 15 |
| 2 bytes | Packet Size = 14 |
| [BEGIN ENCRYPTED AREA] | |
| 1 byte | Status Indicator |
| | 0 = Permission to use save state granted |
| | 1 = Requested save state not found on server |
| | 2 = Subscriber not found on server |
| | 3 = Invalid PIN |
| | 4 = Service not found on server |
| | 5 = Account frozen |
| | 6 = System error |
| 4 bytes | File ID (only present if status = 0) |
| (Pad encrypted area to even 8-byte boundary with zeros) | |
| [END ENCRYPTED AREA] | |
| 2 bytes | CRC |

New Subscriber Card Request

This request is used to associate a new card number with an existing subscriber. This allows players to use multiple cards (including their name or name/SSN combination) to identify themselves to the network.

This request will succeed only if the new card ID is unique throughout the entire ADMIN network.

New Subscriber Card request packets have the following data structure:

| Field Size: | Description: |
|---|---|
| 1 byte | Packet Type = 0 × 81 |
| 1 byte | Packet Subtype = 0 × 16 |
| 2 bytes | Packet Size = 38 |
| [BEGIN ENCRYPTED AREA] | |
| 6 bytes | Terminal ID |
| 4 bytes | Subscriber ID |
| 2 bytes | PIN |
| 1 byte | Card Type |
| | 1 = NANI card |
| | 2 = Credit Card |
| | 3 = Debit card |
| | 4 = Name |
| | 5 = Name and SSN |
| 16 bytes | Card Data |
| (Pad encrypted area to even 8-byte boundary with zeros) | |
| [END ENCRYPTED AREA] | |
| 2 bytes | CRC |

New Subscriber Card Response

When a new subscriber card request is received by the server, it will validate the uniqueness of the card data and create a new card record for the subscriber, returning the result in this packet. New Subscriber Card response packets have the following data structure:

| Field Size: | Description: |
|---|---|
| 1 byte | Packet Type = 0 × 81 |
| 1 byte | Packet Subtype = 0 × 17 |
| 2 bytes | Packet Size = 22 |
| [BEGIN ENCRYPTED AREA] | |
| 6 bytes | Terminal ID |
| 4 bytes | Subscriber ID |
| 1 byte | Status indicator |
| | 0 = Card added successfully |
| | 1 = Card is registered to another subscriber |
| | 2 = Subscriber not found on server |
| | 3 = Invalid PIN |
| | 4 = Card already registered to this subscriber |
| | 5 = Account frozen |
| | 6 = System error |
| (Pad encrypted area to even 8-byte boundary with zeros) | |
| [END ENCRYPTED AREA] | |
| 2 bytes | CRC |

Reserve Merchandise

Reserve merchandise request packets are used to reserve an item of merchandise. The requester can specify attribute values for the item, which the server will try to match.

Reserve merchandise request packets have the following data structure:

| Field Size: | Description: |
|---|---|
| 1 byte | Packet Type = 0 × 81 |
| 1 byte | Packet Subtype = × 18 |
| 2 bytes | Packet Size = 38+ |
| [BEGIN ENCRYPTED AREA] | |
| 6 bytes | Terminal ID |
| 4 bytes | Subscriber ID |
| 2 bytes | PIN |
| 4 bytes | Item ID to reserve |
| 4 bytes | Quantity to reserve |
| 4 bytes | Price offered |
| 1 byte | Number of attributes |
| 1 byte | Attribute ID |
| 2 bytes | Attribute data size |
| Variable | Attribute data |
| (Pad encrypted area to even 8-byte boundary with zeros) | |
| [END ENCRYPTED AREA] | |
| 2 bytes | CRC |

Reserve Merchandise Response

Reserve Merchandise response packets indicate to the requester whether the reservation was successful, and if so, what the actual attribute values of the reserved item is. If the requested quantity could not be met, the largest quantity that could be reserved is returned.

Reserve Merchandise response packets have the following data structure:

| Field Size: | Description: |
|---|---|
| 1 byte | Packet Type = 0 × 81 |
| 1 byte | Packet Subtype = 0 × 19 |
| 2 bytes | Packet Size = 38+ |
| [BEGIN ENCRYPTED AREA] | |
| 6 bytes | Terminal ID |
| 4 bytes | Subscriber ID |
| 4 bytes | Item ID being reserved |
| 1 byte | Status code |
| | 0 Reservation successful |
| | 1 No items remain in inventory |
| | 2 Invalid request |
| | 3 System error |
| 4 bytes | Quantity reserved (on success) |
| 4 bytes | Price of reserved items (on success) |
| 6 bytes | Reservation ID (on success) |
| 1 byte | Number of attributes |
| 1 byte | Attribute ID |
| 2 bytes | Attribute data size |
| Variable | Attribute data |
| (Pad encrypted area to even 8-byte boundary with zeros) | |
| [END ENCRYPTED AREA] | |
| 2 bytes | CRC |

Purchase Merchandise

Purchase merchandise request packets are used to purchase merchandise that was previously reserved with a Reserve merchandise query. The requester can specify attribute values for the item, which the server will try match.

Purchase merchandise request packets have the following data structure:

| Field Size: | Description: |
|---|---|
| 1 byte | Packet Type = 0 × 81 |
| 1 byte | Packet Subtype = 0 ×1A |
| 2 bytes | Packet Size = 30+ |
| [BEGIN ENCRYPTED AREA] | |
| 6 bytes | Terminal ID |
| 4 bytes | Subscriber ID |
| 2 bytes | PIN |
| 6 bytes | Reservation ID (on success) |
| 4 bytes | Purchase price |
| (Pad encrypted area to even 8-byte boundary with zeros) | |
| [END ENCRYPTED AREA] | |
| 2 bytes | CRC |

Purchase Merchandise Response

Purchase Merchandise response packets verify to the requester that the purchase has been processed by the server and that the money should be deducted from the player's funds (either account fees or cash).

Purchase merchandise response packets have the following data structure:

| Field Size: | Description: |
|---|---|
| 1 byte | Packet Type = 0 × 81 |
| 1 byte | Packet Subtype = 0 × 1B |
| 2 bytes | Packet Size = 22 or 30 |
| [BEGIN ENCRYPTED AREA] | |
| 6 bytes | Terminal ID |
| 4 bytes | Subscriber ID |
| 1 byte | Status code |
| | 0 Purchase successful |
| | 1 No items remain in inventory |
| | 2 Invalid request |
| | 3 System error |
| 6 bytes | Order ID (on success) |
| (Pad encrypted area to even 8-byte boundary with zeros) | |
| [END ENCRYPTED AREA] | |
| 2 bytes | CRC |

Release Merchandise

Release merchandise request packets are used to release merchandise that was previously reserved with a Reserve merchandise query. The requester can specify attribute values for the item, which the server will try to match.

Purchase merchandise request packets have the following data structure:

| Field Size: | Description: |
|---|---|
| 1 byte | Packet Type = 0 × 31 |
| 1 byte | Packet Subtype = 0 × 1C |
| 2 bytes | Packet Size = 30 |
| [BEGIN ENCRYPTED AREA] | |
| 6 bytes | Terminal ID |
| 4 bytes | Subscriber ID |
| 2 bytes | PIN |
| 6 bytes | Reservation ID (on success) |
| (Pad encrypted area to even 8-byte boundary with zeros) | |
| [END ENCRYPTED AREA] | |
| 2 bytes | CRC |

Release Merchandise Response

Release merchandise response packets verify to the requester that reserved merchandise has been released.

Purchase merchandise response packets have the following data structure:

| Field Size: | Description: |
|---|---|
| 1 byte | Packet Type = 0 × 81 |
| 1 byte | Packet Subtype = 0 × 1D |
| 2 bytes | Packet Size = 30 |
| [BEGIN ENCRYPTED AREA] | |
| 6 bytes | Terminal ID |
| 4 bytes | Subscriber ID |
| 6 bytes | Reservation ID |
| 1 byte | Status code |
| | 0 Release successful |
| | 1 Invalid request |
| | 2 System error |
| (Pad encrypted area to even 8-byte boundary with zeros) | |
| [END ENCRYPTED AREA] | |
| 2 bytes | CRC |

Subscriber Ranking Request

A request for a subscriber's current ranking in one or more tournament brackets. This can be used to request ranking in brackets that have ended and are beyond their posting period.

Subscriber ranking request packets have the following data structure:

| Field Size: | Description: |
|---|---|
| 1 byte | Packet Type = 0 × 81 |
| 1 byte | Packet Subtype = 0 × 1D |
| 2 bytes | Packet Size = 30+ |
| [BEGIN ENCRYPTED AREA] | |
| 6 bytes | Terminal ID |
| 4 bytes | Subscriber ID |
| 2 bytes | PIN |
| 1 byte | Number of tournament brackets |
| 4 bytes | Tournament ID |
| 1 byte | Bracket ID |
| (Pad encrypted area to even 8-byte boundary with zeros) | |
| [END ENCRYPTED AREA] | |
| 2 bytes | CRC |

Subscriber Ranking Response

The response to the subscriber ranking request packet. This packet contains the subscriber's current position and ranking score in each of the requested tournament brackets that the subscriber has participated in. If the subscriber has not yet played in one of the requested brackets, or the bracket is not found on the server, it will not be included in the list.

Subscriber ranking response packets have the following data structure:

| Field Size: | Description: |
|---|---|
| 1 byte | Packet Type = 0 × 81 |
| 1 byte | Packet Subtype = 0 × 1E |
| 2 bytes | Packet Size = 22 |
| [BEGIN ENCRYPTED AREA] | |
| 1 byte | Status |
| | 0 = Query succeeded |
| | 1 = Account frozen |
| | 2 = Subscriber not found |
| | 3 = Invalid PIN |
| | 4 = System error |
| 4 bytes | Subscriber ID |
| 1 byte | Number of tournament brackets |
| 4 bytes | Tournament ID |
| 1 byte | Bracket ID |
| 2 bytes | Rank |
| 4 bytes | Score |
| 4 bytes | Score Date and Time |
| (Pad encrypted area to even 8-byte boundary with zeros) | |
| [END ENCRYPTED AREA] | |
| 2 bytes | CRC |

Event Packets

Event packets are transmitted on sockets connected to the Event services IP port, or over an asynchronous POS network connection. In either case, they use a transmit-ack lockstep exchange. The client transmits an event packet, the server responds with an Ack. If the server does not respond within 1 second, the client resends the event packet up to 5 times, then fails and moves on to its next event. If the server sends a Nak, the packet should be resent right away. These timeouts may need to be tuned for Internet-based transmission.

The entire data portion of the event packet is encrypted using the encryption parameters negotiated for the connection.

Alarm

Alarm event packets have the following data structure:

| Field Size: | Description: |
|---|---|
| 1 byte | Packet Type = 0 × 82 |
| 1 byte | Packet Subtype = 0 × 00 |
| 2 bytes | Packet Size |
| [BEGIN ENCRYPTED AREA] | |
| 6 bytes | Terminal ID of the machine reporting the |
| | alarm |
| 2 bytes | Alarm code being reported (LSB first) |
| | Currently defined values are shown below. |
| 4 bytes | Time the alarm was reported (UTC format, LSB |
| | first) |
| 1 byte | Flag indicating whether the alarm was handled |
| | by the terminal |
| | (1 if the terminal handled the alarm |
| | with a local handler) |
| 2 bytes | Alarm data size (LSB first) |
| Variable | Alarm data. The content of this field |
| | depends on the alarm type. The formats for |
| | each defined alarm code are shown below. |
| (Pad data portion of packet to even 8-byte boundary with | |
| zeros) | |
| [END ENCRYPTED AREA] | |
| 2 bytes | CRC |

| Alarm | | |
|---|---|---|
| Code: | Meaning: | Data: |
| 1 | Hard reset (power up) | None |
| 2 | Soft reset | None |
| 3 | Hardware failure | ASCII diagnostic message |
| | | (optional) |
| 4 | Firmware failure | ASCII diagnostic message |
| | | (optional) |
| 5 | Bill acceptor full | None |
| 6 | Coin jam | None |
| 7 | Bill jam | None |
| 8 | Network disabled | None |
| 12 | Game time-out | None |
| 13 | Hard drive full | None |
| 18 | Printer error | None |
| 19 | Printer paper low | None |
| 22 | Cable disconnected | ASCII diagnostic message |
| | | (optional) |
| 23 | Security alarm | Binary position of |
| | | switch positions (use 32 |
| | | bits) |
| 24 | Enabled by technician | Technician ID enabling |
| | | terminal |
| 25 | Disabled by technician | Technician ID disabling |
| | | terminal |
| 26 | Immediate call requested | None |
| 27 | Queue entry aged | None |
| 29 | Serial number changed | None |

Alarm events are queued to the server as soon as they are detected. Alarms of the following types are considered critical and should be transmitted right away:

| | |
|---|---|
| Hardware failure | Firmware failure |
| Bill acceptor full | Coin jam |
| Bill jam | Printer error |
| Cable disconnected | Security alarm |
| Immediate call request | |

Tournament Play

Tournament play event packets have the following data structure:

| Field Size: | Description: |
|---|---|
| 1 byte | Packet Type = 0 × 82 |
| 1 byte | Packet Subtype = 0 × 01 |
| 2 bytes | Packet Size |
| [BEGIN ENCRYPTED AREA] | |
| 4 bytes | Subscriber ID playing the tournament game |
| | (LSB first) |
| 6 bytes | Terminal ID on which the tournament game was |
| | played |
| 4 bytes | Service ID on which tournament game was |
| | played (LSB first) |
| 2. byte | Player Station (8 bit flags, position 0 = |
| | station 1, etc.) |
| 1 byte | Active Station (8 bit flags, position 0 = |
| | station 1, etc.) |
| 4 bytes | Start Date and Time (UTC format, LSB first) |
| 4 bytes | End Date and Time (UTC format, LSB first) |
| 1 byte | Flags |
| | 0 × 01 Equipment failed during game |
| | 0 × 02 Score is invalid |
| | 0 × 04 Player should be disqualified |
| 1 byte | Number of statistics (in) |
| 4 bytes | Statistic ID (LSB first) |
| 4 bytes | Statistic Value (LSB first) |
| . | |
| . | |
| . | |
| 1 byte | Number of tournament games entered with the |
| | play (m) |
| 4 bytes | Tournament ID entered (LSB first) |
| 1 byte | Bracket ID entered |
| 4 bytes | Derived score achieved by subscriber (LSB |
| | first) |
| . | |
| . | |
| . | |
| (Pad data portion of packet to even 8-byte boundary with | |
| zeros) | |
| [END ENCRYPTED AREA] | |
| 2 bytes | CRC |

Redemption Play

Redemption play event packets have the following data structure:

| Field Size: | Description: |
|---|---|
| 1 byte | Packet Type = 0 × 82 |
| 1 byte | Packet Subtype = 0 × 02 |
| 2 bytes | Packet Size |
| [BEGIN ENCRYPTED AREA] | |
| 4 bytes | Subscriber ID playing redemption game (LSB |
| | first) |
| 6 bytes | Terninal ID on which redemption game was |
| | played |
| 4 bytes | Service ID on which redemption game was |
| | played (LSB first) |
| 1 byte | Player Station (8 bit flags, position 0 = |
| | station 1, etc.) |
| 1 byte | Active Stations (8 bit flags, position 0 = |
| | station 1, etc.) |
| 4 bytes | Start Date and Time (UTC format, LSB first) |
| 4 bytes | End Date and Time (UTC format, LSB first) |
| 1 byte | Flags |
| | 0 × 01 Equipment failed during game |
| | 0 × 02 Score is invalid |
| 1 byte | Number of statistics (n) |
| 4 bytes | Statistic ID (LSB first) |
| 4 bytes | Statistic Value (LSB first) |
| . | |
| . | |
| . | |
| 1 byte | Number of redemption games entered with the |
| | play (m) |
| 4 bytes | Redemption ID (LSB first) |
| 2 bytes | Par level beaten (LSB first) |
| 4 bytes | Par score beaten (LSB first) |
| 4 bytes | Derived score achieved by subscriber (LSB |
| | first) |
| 4 bytes | Pool amount awarded (LSB first) |
| (Pad data portion of packet to even 8-byte boundary with | |
| zeros) | |
| [END ENCRYPTED AREA] | |
| 2 bytes | CRC |

Meter Readings

Meter readings event packets have the following data structure:

| Field Size: | Description: |
|---|---|
| 1 byte | Packet Type = 0 × 82 |
| 1 byte | Packet Subtype = 0 × 03 |
| 2 bytes | Packet Size |
| [BEGIN ENCRYPTED AREA] | |
| 6 bytes | Terminal ID on which the meters were |
| | collected |
| 4 bytes | The date and time meters were collected (in |
| | UTC format, LSB first) |
| 2 bytes | Number of terminal meters included (LSB |
| | first) (n) |
| 4 bytes | Terminal Meter ID (LSB first) |
| 4 bytes | Terminal Meter Value (LSB first) |
| . | |
| . | |
| . | |
| 2 bytes | Number of service meters (LSB first) (m) |
| 4 bytes | Service ID of the meter (LSB first) |
| 4 bytes | Meter ID of the meter (LSB first) |
| 4 bytes | Meter Value of the meter (LSB first) |
| (Pad data portion of packet to even 8-byte boundary with | |
| zeros) | |
| [END ENCRYPTED AREA] | |
| 2 bytes | CRC |

Terminal manufacturers should support as many of the following pre-defined terminal meter IDs as possible, as well as any additional meters available:

| Meter ID: | Meaning: |
|---|---|
| 1 | Left slot coins in |
| 2 | Right slot coins in |
| 3 | 3^{rd} slot coins in |
| 4 | 4^{th} slot coins in |
| 5 | Paid credits |
| 6 | Total collection (in cents) |
| 7 | Service credits |
| 8 | Total plays |
| 9 | Total uptime (minutes) |
| 10 | Number of hard resets |
| 11 | Number of soft resets |

Terminal meters should never reset to zero. They should accumulate in 32-bit fields over the lifetime of the terminal. Relative values will be computed between two consecutive readings at the database.

Ad Statistics

Ad statistics event packets have the following data structure:

| Field Size: | Description: |
|---|---|
| 1 byte | Packet Type = 0 × 82 |
| 1 byte | Packet Subtype = 0 × 04 |
| 2 bytes | Packet Size |
| [BEGIN ENCRYPTED AREA] | |
| 6 bytes | Terminal ID on which the statistics were |
| | collected |
| 4 bytes | The date and time statistics were collected |
| | (in UTC format, LSB first) |
| 2 bytes | Number of unidentified ads (n) |
| 4 bytes | Target ID (LSB first) |
| 4 bytes | Number of plays |
| . | |
| . | |
| . | |
| 2 bytes | Number of identified ad exposures (LSB first) (m) |
| 4 bytes | Target ID (LSB first) |
| 4 bytes | Subscriber ID (LSB first) |
| 4 bytes | Date and time the ad was played (UTC |
| | format, LSB first) |
| (Pad data portion of packet to even 8-byte boundary with | |
| zeros) | |
| [END ENCRYPTED AREA] | |
| 2 bytes | CRC |

Ad statistics are accumulated on each terminal and queued at midnight each night (or whenever the terminal detects the current day has changed, in case it is powered off at midnight). The packet reports all ad plays for the day. As soon as this packet is queued, the ad play records can be deleted from the terminal, and a new day's record keeping begun. The queued entry must not be deleted until successfully received at the server and acknowledged.

Service Accesses

Service accesses event packets have the following data structure:

| Field Size: | Description: |
|---|---|
| 1 byte | Packet Type = 0x82 |
| 1 byte | Packet Subtype = 0x05 |
| 2 bytes | Packet Size |
| [BEGIN ENCRYPTED AREA] | |
| 6 bytes | Terminal ID on which the statistics were |
| | collected |
| 4 bytes | The date and time statistics were collected |
| | (in UTC format, LSB first) |
| 2 bytes | Number of service accesses being reported |
| | (LSB first) (n) |
| 4 bytes | Service ID being accessed (LSB first) |
| 1 byte | Profile used |
| 4 bytes | Start date and time of access (UTC format, |
| | LSB first) |
| 4 bytes | End date and time of access (UTC format, |
| | LSB first) |
| 4 bytes | Subscriber ID (LSB first) |
| 4 bytes | Cash funds used (LSB first) |
| 4 bytes | Account funds used (LSB first) |
| . . . | |
| (Pad data portion of packet to even 8-byte boundary with | |
| zeros) | |
| [END ENCRYPTED AREA] | |
| 2 bytes | CRC |

This packet tracks all accesses to any service on the terminal. Each time a player plays a game or engages in a session in any other service, the data should be stored. This packet should be generated each evening at midnight for the day's service accesses (or whenever the terminal detects the current day has changed).

Down Time

Down time event packets have the following data structure:

| Field Size: | Description: |
|---|---|
| 1 byte | Packet Type = 0x82 |
| 1 byte | Packet Subtype = 0x06 |
| 2 bytes | Packet Size |
| [BEGIN ENCRYPTED AREA] | |
| 6 bytes | Terminal ID on which the down times are being |
| | reported |
| 4 bytes | The date and time down times were reported |
| | (in UTC format, LSB first) |
| 2 bytes | Number of down times being reported (LSB |
| | first) (n) |
| 4 bytes | Technician ID responsible for the down |
| | time (LSB first) |
| 4 bytes | Start date and time of down time (UTC |
| | format, LSB first) |
| 4 bytes | End date and time of down time (UTC |
| | format, LSB first) |
| . . . | |
| (Pad data portion of packet to even 8-byte boundary with | |
| zeros) | |
| [END ENCRYPTED AREA] | |
| 2 bytes | CRC |

This packet tracks all down times experienced by a terminal. Games should periodically update some non-volatile timestamp while they are running, and then test this value on powerup to see how long the power outage was, and report this as down time. When a technician administratively takes the game down through a service menu, this is also logged in this packet. This packet should be generated each evening at midnight for the day's down times (or whenever the terminal detects the current day has changed).

New Subscriber

New subscriber event packets have the following data structure:

| Field Size: | Description: |
|---|---|
| 1 byte | Packet Type = 0x82 |
| 1 byte | Packet Subtype = 0x07 |
| 2 bytes | Packet Size |
| [BEGIN ENCRYPTED AREA] | |
| 6 bytes | Terminal ID on which the subscriber |
| | registered |
| 4 bytes | Subscriber ID being registered (LSB first) |
| 26 bytes | Alias entered by the subscriber |
| 26 bytes | Street address entered by the subscriber |
| 10 bytes | Postal code entered by the subscriber |
| 10 bytes | Phone number entered by the subscriber |
| 20 bytes | First name entered by subscriber |
| 20 bytes | Last name entered by subscriber |
| 2 bytes | Middle initial entered by subscriber |
| 1 byte | Birth day entered by subscriber |
| 1 byte | Birth month entered by subscriber |
| 2 bytes | Birth year entered by subscriber (LSB first) |
| 1 byte | Gender entered by subscriber (0 = male, |
| | 1 = female) |
| 9 bytes | SSN entered by subscriber |
| 2 bytes | PIN entered by the subscriber |
| 1 byte | Number of cards to register |
| 1 byte | Card Type |
| | 1 = ADMIN card |
| | 2 = Credit card |
| | 3 = Debit card |
| | 4 = Name |
| | 5 = Name and SSN |
| 16 bytes | Card Data |
| . . . | |
| (Pad data portion of packet to even 8-byte boundary with | |
| zeros) | |
| [END ENCRYPTED AREA] | |
| 2 bytes | CRC |

New subscriber events are queued when players register a new card. They are queued at the time the data is entered, but do not need to be sent right away. However, if the player subsequently plays any games that generate queue entries, the terminal must ensure that this event is transmitted to the server before any game plays for that player. This is to ensure that the server has established an account for the player before attaching a game play to it.

Any of the registered cards that are included in the packet that already exist on the server or fail for some other reason will be skipped, but the subscriber will be created regardless. A card of type “NANI Card” with a card ID equal to the value of the subscriber ID will be created automatically.

New Team

New team event packets have the following data structure:

| Field Size: | Description: |
|---|---|
| 1 byte | Packet Type = 0x82 |
| 1 byte | Packet Subtype = 0x08 |
| 2 bytes | Packet Size |
| [BEGIN ENCRYPTED AREA] | |
| 6 bytes | Terminal ID on which the subscriber |
| | registered |
| 4 bytes | Subscriber ID of team being registered (LSB |
| | first) |
| 26 bytes | Alias entered by the team |
| 2 bytes | PIN entered for team |
| 1 byte | Number off members |
| 4 bytes | Subscriber ID |
| 1 byte | Flags |
| . . . | |
| (Pad data portion of packet to even 8-byte boundary with | |
| zeros) | |
| [END ENCRYPTED AREA] | |
| 2 bytes | CRC |

New team events are queued when teams register. They are queued at the time the data is entered, but do not need to be sent right away. However, if the team subsequently plays any games that generate queue entries, the terminal must ensure that this event is transmitted to the server before any game plays for that team. This is to ensure that the server has established an account for the team before attaching a game play to it.

Issued Coupons

Issued coupons event packets have the following data structure:

| Field Size: | Description: |
|---|---|
| 1 byte | Packet Type = 0x82 |
| 1 byte | Packet Subtype = 0x09 |
| 2 bytes | Packet Size |
| [BEGIN ENCRYPTED AREA] | |
| 6 bytes | Terminal ID on which the down times are being |
| | reported |
| 2 bytes | Number of coupons being reported (LSB first) |
| | (n) |
| 4 bytes | Coupon ID issued (LSB first) |
| 4 bytes | Subscriber ID coupon was issued to (LSB |
| | first) |
| 4 bytes | Date and time coupon was issued (UTC |
| | format, LSB first) |
| 6 bytes | Receipt ID |
| 1 byte | Flags |
| . . . | |
| (Pad data portion of packet to even 8-byte boundary with | |
| zeros) | |
| [END ENCRYPTED AREA] | |
| 2 bytes | CRC |

This packet tracks all coupons issued by a terminal. This packet should be generated each night at midnight for the day's coupons (or whenever the terminal detects the current day has changed).

Loyalty Point Awards

Loyalty point award event packets have the following data structure:

| Field Size: | Description: |
|---|---|
| 1 byte | Packet Type = 0x82 |
| 1 byte | Packet Subtype = 0x0A |
| 2 bytes | Packet Size |
| [BEGIN ENCRYPTED AREA] | |
| 6 bytes | Terminal ID on which the awards are being |
| | reported |
| 2 bytes | Number of awards being reported (LSB first) |
| | (n) |
| 4 bytes | Subscriber ID receiving the award (LSB |
| | first) |
| 4 bytes | Loyalty Program ID (LSB first) |
| 2 bytes | Number of points awarded (LSB first) |
| 4 bytes | Date and time the award was made UTC |
| | format, LSB first) |
| . . . | |
| (Pad data portion of packet to even 8-byte boundary with | |
| zeros) | |
| [END ENCRYPTED AREA] | |
| 2 bytes | CRC |

This packet tracks all loyalty points awarded by a terminal. This packet should be generated each evening at midnight for the day's awards (or whenever the terminal detects the current day has changed).

Synchronization Packets

Inventory

Inventory packets have the following data structure:

| Field Size: | Description: |
|---|---|
| 1 byte | Packet Type = 0x83 |
| 1 byte | Packet Subtype = 0x00 |
| 2 bytes | Packet Size |
| [BEGIN ENCRYPTED AREA] | |
| 6 bytes | Terminal ID issuing the request (or 0 for |
| | server inventories) |
| 2 bytes | System software version (LSB first) |
| 2 bytes | Number of records (LSB first) (n) |
| 1 byte | Table ID the record belongs to |
| 4 bytes | Record ID |
| . . . | |
| 2 bytes | Number of files (LSB first) (m) |
| 4 bytes | File ID (LSB first) |
| . . . | |
| 2 bytes | Number of content objects (LSB first) (m) |
| 4 bytes | Content ID (LSB first) |
| . . . | |
| (Pad encrypted area to even multiple of 8 bytes) | |
| [END ENCRYPTED AREA) | |
| 2 bytes | CRC |

Data is guaranteed to be in order of ascending table ID, but not necessarily in order of ascending record ID within each table ID.

Table Download

Downloaded table records are inserted directly into the database, using the record ID as a key. Any existing records with the same record ID are overwritten. A table download packet with 0 records is used to indicate no more data.

Table download packets have the following data structure:

| Field Size: | Description: |
|---|---|
| 1 byte | Packet Type = 0x83 |
| 1 byte | Packet Subtype = 0x01 |
| 2 bytes | Packet Size |
| [BEGIN ENCRYPTED AREA] | |
| 1 byte | Table ID being downloaded |
| 2 bytes | Number of records (LSB first) (n) |
| 6 bytes | Record ID of a record in the table (LSB |
| | first) |
| 2 bytes | Record data size (in bytes, LSB first) |
| Variable | Record data |
| . . . | |
| (Pad encrypted area to even multiple of 8 bytes) | |
| [END ENCRYPTED AREA] | |
| 2 bytes | CRC |

File Initial Download

File Initial Download packets have the following data structure:

| Field Size: | Description: |
|---|---|
| 1 byte | Packet Type = 0x83 |
| 1 byte | Packet Subtype = 0x02 |
| 2 bytes | Packet Size |
| [BEGIN ENCRYPTED AREA] | |
| 4 bytes | File ID being downloaded (LBS first) |
| 4 bytes | Total file size (LSB first) |
| 4 bytes | File flags (compression info, permissions, |
| | etc. - TBD) |
| 2 bytes | Number of segments (LSB first) |
| 1 byte | Path length |
| Variable | pathname on local machine |
| (Pad encrypted area to even multiple of 8-bytes) | |
| [END ENCRYPTED AREA] | |
| 2 bytes | CRC |

File Next Download

File Next Download packets have the following data structure:

| Field Size: | Description: |
|---|---|
| 1 byte | Packet Type = 0x83 |
| 1 byte | Packet Subtype = 0x03 |
| 2 bytes | Packet Size |
| [BEGIN ENCRYPTED AREA] | |
| 4 bytes | File ID being downloaded (LBS first) |
| 2 bytes | Segment number (LSB first) |
| 2 bytes | Segment data size (LSB first) |
| Variable | Segment data |
| (Pad encrypted area to even multiple of 8-bytes) | |
| [END ENCRYPTED AREA] | |
| 2 bytes | CRC |

File Initial Upload

File Initial Upload packets have the following data structure:

| Field Size: | Description: |
|---|---|
| 1 byte | Packet Type = 0x83 |
| 1 byte | Packet Subtype = 0x04 |
| 2 bytes | Packet Size |
| [BEGIN ENCRYPTED AREA] | |
| 4 bytes | File ID being uploaded (LBS first) |
| 4 bytes | Total file size (LSB first) |
| 4 bytes | File flags (compression info, permissions, |
| | etc. - TBD) |
| 2 bytes | Number of Segments (LSB first) |
| 1 byte | Filename length |
| Variable | Filename |
| (Pad encrypted area to even multiple of 8-bytes) | |
| [END ENCRYPTED AREA] | |
| 2 bytes | CRC |

Retrieve File

A request to transfer a file to a client if the client's version of the file is missing or out of date. Retrieve file request packets have the following data structure:

| Field Size: | Description: |
|---|---|
| 1 byte | Packet Type = 0x81 |
| 1 byte | Packet Subtype = 0x1F |
| 2 bytes | Packet Size = 22 |
| [BEGIN ENCRYPTED AREA] | |
| 1 byte | File Type |

0 = Content
1 = Service file

| 4 bytes | File ID |
|---|---|
| 4 bytes | Current file size |
| 4 bytes | Current file modification date |
| 2 bytes | Current file CRC |
| (Pad encrypted area to even 8-byte boundary with zeros) | |
| [END ENCRYPTED AREA] | |
| 2 bytes | CRC |

Retrieve File Response

This packet is sent to the client immediately if the requested file is up to date, or does not exist, or after a series of file download packets if the file needs to be downloaded.

Retrieve file request packets have the following data structure:

| Field Size: | Description: |
|---|---|
| 1 byte | Packet Type = 0x81 |
| 1 byte | Packet Subtype = 0x20 |
| 2 bytes | Packet Size = 22 |
| [BEGIN ENCRYPTED AREA] | |
| 1 byte | Status |

0 = File downloaded successfully
1 = Current file is up to date
2 = Error downloading
3 = File not found
4 = System error

| 4 bytes | File ID |
|---|---|
| 4 bytes | Current file size |
| 4 bytes | Current file modification date |
| 2 bytes | Current file CRC |
| (Pad encrypted area to even 8-byte boundary with zeros) | |
| [END ENCRYPTED AREA] | |
| 2 bytes | CRC |

For the synchronization function, assuming that the inventory of a subscriber is being downloaded, e.g. from a database associated with a regional server to a database associated with an arcade, public PC or validation and redemption terminal, the packets can add a field (e.g. 4 bytes) which identifies the subscriber.

The administration terminal 43 contains a database which specifies the entire system, in subdatabases which can be specified as classes. The content of the complete database, or the content of each subdatabase can be specified by a single administration entity, or any can be specified by authorized suppliers. In the latter case, the content of the subdatabases can be filled by communication between the terminal 43 and suppliers' terminals, using the system shown in FIG. 1.

Subdatabases are preferred to relate to the following:

| | |
|---|---|
| Suppliers | Locations |
| Game Machines | Game Software |
| Redemptions | Tournaments |
| Merchandise Categories | Pricing |
| Prizes | Alarms |
| Schedules | Manufacturers |
| Subscribers | Technicians |
| Advertising | Content |
| Coupons | Loyalty Programs |
| Promotions | Services |
| Profile Descriptor (e.g. VALs) | |

VAL™ is a standard profile descriptor which has been adopted by some companies. VALs or class systems used by other companies can be stored and used in addition to or as a replacement for the demographic classification described herein.

Game Software is an example of the above. A field of the above can be the identification of a game which is located on a CD ROM, hard disk drive, DVD or mass semiconductor or other storage means at a game location. Another field can be an algorithm which controls the parameters of the game. Another field can store score brackets which a player must reach in order to win a prize. Another field can store timing information which can be used to modify the brackets. Other fields can be filled with other data required for the game.

The other subdatabases can be similarly filled with data to specify the operation of each parameter of the system. For example, a merchant can specify a premium related to the merchant's store as a prize to the player of a game at an arcade nearby to the store. A field in the prize or coupon subdatabase can point to the game or games for which the premium or coupon is to be distributed, another can specify a score bracket to be achieved (which can be >0) by the player in order to win the premium or coupon, etc.

Once the database has been completed to a required level, the subdatabases are downloaded to the decision support server 7, which stores it in its database 9. The decision support server then downloads the data as related to the various peripheral terminals to the associated regional servers, which in turn store required data in their respective databases 5A to 5N, and download the data related to the respective terminals to those that are appropriate.

For example, regional server 5A downloads initialization parameters to the master games 21 in the arcades in which authorized game machines are located which can communicate with the regional server 5A. It also downloads initialization parameters to the software at the public PCs with which it can communicate, which have been authorized at the administration location.

As a further example, the initialization parameters may initialize or authorize operation of particular video games, with particular score brackets, at the arcade 17 and/or at the public PC. The initialization parameters may also initialize a program at the public PC which controls acceptance of payments, and/or acceptance of orders for merchandise, and/or redemption of premiums, etc., and also controls transmission of data to the regional server which updates the account of the customer in currency or other media of exchange such as loyalty points, etc.

Table 1 which is attached at the end of this specification describes preferred subdatabases to be established initially at the administration terminal, which specify games, software, advertisements and other matters, and their parameters, which are downloaded to the terminals in a manner as described above. Each of the subdatabases is headed by a table name, and each of the fields describes the content of the field; its content and use are self evident from the name chosen.

It was noted above that parameters can be downloaded for the operation of a game. The shell of a game can have a requirement for score formulae to be inserted. The score formulae can be determined at the administration terminal, and downloaded as noted earlier, as one or more parameters of the game.

For example, consider the Pacman™ game. Key graphical elements of the game are dots, fruits, ghosts, and the game requires a scope. These elements can be used in formulae; for example the dots can be given a statistic S00, the fruits a statistic S01, the ghosts a statistic S02 and the scope a statistic 303.

A formula can be determined, e.g. (S00+5) * S03 to determine an output score for dots, for example. The formulae can be modified by a player rating, the player having been identified by his ID card that has been swiped. The formulae can be modified by the time of day, the number of games played in a certain time interval, the score brackets achieved by players in a certain time interval, etc.

Indeed, a game can be refreshed by formulae which change the object of a game. An easy game can be made more difficult or different based on the formulae for a particular player profile.

Loyalty points, coupons or other prizes can be awarded based on different formulae. These can be specified by different suppliers' terminals interacting with the administration terminal, or solely at the administration terminal.

Prizes can be awarded based on a history of plays at a particular location. Par level and score brackets can be automatically adjusted. With reference to FIG. 3, a histogram is shown of scores of a game against the number of plays achieving the scores. Within the region A, the top 10% of scores occur. Within the region B, the next 20% of scores occur, and within the region C, the next 30% of scores occur. A supplier determines, through the administration terminal, that the best prizes should be awarded for the scores in region A, the next best prizes for the scores in region B, and the lowest prize for the scores in region C.

The software can store the scores, and supply the scores to the game shell software to adjust the regions A, B and C, depending on how well and how many players play, and the history of prize redemptions at the particular game location, as specified by parameters input at the administration terminal. This can consist of adding the scores together, and if there have been prize redemptions in excess of a predetermined number established at the administration terminal, skewing the scores, or multiplying the scores, by a number or game handicap value. This process of skewing, in effect varies the shape and placement of the curve shown in FIG. 3, and provides an automatic par or bracket adjustment for the game.

The software can also keep track of a player's score on a particular game and store it in the player's database, and can forbid the awarding of a prize to the player for a particular game within a certain time interval or within a certain arcade. This will stop a good player from collecting too many prizes or too large a prize on a single machine if the number of players is low, or if the player monopolizes a game.

It should be noted that while the description herein is to a client-server type system which communicate in a particular manner, the equivalent function and structure of the invention could also be realized by persons skilled in the art understanding this invention via one or more browsers which interface one or more web pages, either via the internet or on one or more intranets which are either self-contained or which communicate via the internet, or via private network.

A person understanding this invention may now conceive of alternate embodiments and enhancements using the principles described herein. All such embodiments and enhancements are considered to be within the spirit and scope of this invention as defined in the claims appended hereto.

[image]

[image]

[image]

[image]

[image]

[image]

[image]

[image]

[image]

[image]

[image]

[image]

[image]

[image]

[image]

[image]

[image]

[image]

I claim:

1. A system for controlling operation of an electronic game, comprising control hardware and software for electronically displaying and controlling the game, said system comprising:
an administration station for inputting and storing parameters relating to game play,
a video game terminal in which the game is played,
means for downloading the parameters from the administration station to the terminal,
said control hardware and software being conditioned from the administration station and the operation of the game is controlled by said stored parameters at said administration station,
said control hardware is in said video game terminal and said control software is stored in an electronic memory of said terminal.

2. A system as defined in claim 1 in which said control software includes default parameters which are replaced by said parameters downloaded from the administration station.

3. A system as defined in claim 1 in which at least one of the parameters is comprised of a formula containing variables which relate to the game.

4. A system as defined in claim 1, further including a regional server in said means for downloading for receiving the parameters input on the administration station, storing the parameters, and for downloading the parameters to the video game terminal.

5. A system as defined in claim 4 in which the game is one of several games of an arcade, one of the games of the arcade being designated as a master game, a memory in communication with the several games of the arcade, the downloaded parameters being stored in the memory via the master game prior to use thereof by any of the games.

6. A system as defined in claim 5 in which at least one of the parameters is comprised of a formula containing variables which relate to the game.

7. A system as defined in claim 4, including a network for sending scores achieved by the games to said administration station having means for determining the number of players of a particular game achieving various score levels, and adjusting at least one of par or score bracket levels as indicators of game achievement based on a predetermined algorithm.

8. A system as defined in claim 1 in which the game is one of several games of an arcade, one of the games of the arcade being designated as a master game, having a memory in communication with the other games of the arcade, the downloaded parameters being stored in said memory of the master game prior to use thereof by any of the games.

9. A system as defined in claim 8, the master game having means for determining the number of players of a particular game achieving various score levels, and means for adjusting at least one of par or score bracket levels as indicators of game achievement based on a predetermined algorithm.

10. A system as defined in claim 9 in which the algorithm comprises means for changing at least one of said parameters.

11. A system as defined in claim 10 including player identifier means, the master game having means for indicating a loyalty point value based on a score achieved by an identified player as having a relationship to the par score or to the bracket levels, and for loading said loyalty point value to said administration station for credit to a database credit account of the identified player.

12. A system as defined in claim 11 in which the loyalty point value corresponds to at least one of the parameters.

13. A system as defined in claim 1, including a network for uploading a score achieved by an identified player to a regional server, the regional server having means for indicating a loyalty point value based on the score achieved by the identified player as having a relationship to the par score or to bracket levels, the regional server having means for storing the loyalty points in a database credit account of the identified, player.

14. A method of controlling operation of an automatic game comprising:
(a) providing a local automatic game having variable operating parameters,
(b) downloading the operating parameters from a database, and
(c) operating the game with the downloaded parameters.

15. A method as defined in claim 14, in which the parameters are comprised of at least one formula for controlling the game generated and displayed by the local automatic game.

16. A method as defined in claim 14 in which the parameters specify at least one characteristic of the game and scores granted during the operation of the game resulting from manipulation of the game by a player.

17. A method as defined in claim 16 in which other downloaded parameters are comprised of score achievement brackets or a par score.

18. A method as defined in claim 15 in which other downloaded parameters are comprised of score achievement brackets or a par score.
